(19) United States
(12) Patent Application Publication
(10) Pub. No.: US 2016/0004741 A1
(43) Pub. Date: Jan. 7, 2016

(54) METHOD AND APPARATUS FOR MANAGING CORPORATE DATA

(71) Applicant: Encompass Corporation Pty Ltd., Sydney (AU)

(72) Inventors: Wayne Noel Johnson, Asquith (AU); Richard Lloyd Jones, Kambah (AU)

(21) Appl. No.: 14/320,738

(22) Filed: Jul. 1, 2014

(51) Int. Cl. G06F 17/30; G06F 21/62

(52) U.S. Cl. CPC G06F 17/30345; G06F 21/6218

(57) ABSTRACT

A method of managing corporate data, the method including, in one or more electronic processing devices hosting a workspace associated with workspace corporate data, providing users access to the workspace in accordance with user access permissions to thereby allow the users to perform actions relating to the workspace corporate data, the actions including at least one of selecting workspace corporate data to be acquired from one or more corporate data sources, viewing the workspace corporate data, manipulating the workspace corporate data and updating the workspace corporate data.

### BACKGROUND OF THE INVENTION

This invention relates to a method and apparatus for managing corporate data.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Commercial reports provide information about specific entities such as companies, real estate and persons, with a specific focus such as company structure, real estate ownership and financial status. They are invariably created on demand from an underlying information source such as a company regulator, who typically holds the underlying information in a semi-structured form such as that provided by XML (eXtensible Markup Language) and who may make the information available at a charge. Commercial reports may also be updated by the information source at any time without reference to the user of the report who therefore may unknowingly be holding an out of date copy.

The entities together with the links between them that are referred to in a commercial report may be visualized in the form of a network chart where the entities form the nodes and the roles or other associations, in the context of the report, form the links. Because reports from different sources may refer to the same entity, a single network chart can provide a visual representation of the content of more than one report, showing the links to shared entities.

Users of commercial reports and network charts are exploiting the information in them for important purposes, which can require standard well-defined processes lasting significant timeframes, and involve teams of people with defined roles. Because the information is of high value to the user, it is essential that the user is able to ensure that the information is the most current and that it can be processed in ways that meet the requirements of the organisation.

### SUMMARY OF THE PRESENT INVENTION

In one broad form the present invention seeks to provide a method of managing corporate data, the method including, in one or more electronic processing devices:
a) hosting a workspace associated with workspace corporate data;
b) providing users access to the workspace in accordance with user access permissions to thereby allow the users to perform actions relating to the workspace corporate data, the actions including at least one of:
   i) selecting workspace corporate data to be acquired from one or more corporate data sources;
   ii) viewing the workspace corporate data;
   iii) manipulating the workspace corporate data; and,
   iv) updating the workspace corporate data.

Typically the method includes, in the one or more electronic processing devices, displaying a workspace representation, the workspace representation including at least one of:
a) an indication of the workspace corporate data;
b) an indication of one or more reports forming part of the workspace corporate data;
c) an indication of one or more entities to which the workspace corporate data relates; and,
d) a network representation of the corporate data.

Typically the method includes, in the one or more electronic processing devices:
a) generating a link indicative of a workspace address; and,
b) providing the link to users to thereby allow user access to the workspace.

Typically the method includes, in the one or more electronic processing devices:
a) generating a notification including the link; and,
b) transferring the notification to the user.

Typically the method includes, in the one or more electronic processing devices:
a) determining, in accordance with input commands from a first user, a user identifier indicative of an identity of a second user permitted to access the workspace; and,
b) recording an indication of the second user identifier as part of user data associated with the workspace.

Typically the method includes, in the one or more electronic processing devices:
a) determining, in accordance with input commands from the first user, user permissions associated with the second user, the user permissions being indicative of actions the second user can perform; and,
b) recording an indication of the user permissions as part of the user data.

Typically the method includes, in the one or more electronic processing devices:
a) receiving a share workspace request from the first user;
b) displaying a list of potential users; and,
c) determining the user identifier of the second user in accordance with selection of a potential user from the list of users.

Typically the method includes, in the one or more electronic processing devices:
a) displaying, as part of a workspace representation, a share workspace option; and,
b) receiving a share workspace request from the first user in accordance with selection of the share workspace option by the first user.

Typically the method includes, in the one or more electronic processing devices:
a) receiving a workspace access request including an indication of a user identifier;
b) comparing the user identifier to the user data; and,
c) selectively providing access to the corporate data in the workspace in accordance with the results of the comparison.

Typically the method includes, in the one or more electronic processing devices, creating the workspace in accordance with input commands from a user.

Typically the method includes, in the one or more electronic processing devices:
a) determining a selection of workspace corporate data to be acquired in accordance with user input commands from a first user;
b) displaying the indication of the selection to a second user;
c) acquiring the corporate data in accordance with input commands from the second user; and,
d) displaying the workspace corporate data to the first user.

Typically the method includes, in the one or more electronic processing devices, manipulating the workspace corporate data at least partially in accordance with user input commands.

Typically the method includes, in the one or more electronic processing devices:
a) determining, in accordance with input commands from a user, changes in at least one of:
   i) the workspace corporate data; and,
   ii) a representation of the workspace corporate data; and,
b) recording an indication of the changes together with a user identifier of the user.

Typically the workspace corporate data includes one or more reports relating to one more entities, and wherein the method includes, in the one or more electronic processing devices:
a) identifying, from a report source, changes in the reports; and,
b) selectively updating a report by acquiring an updated report from the report source in accordance with input commands from a user.

Typically the method includes, in the one or more electronic processing devices, comparing report details of each report to report details from a report source to determine changes in the reports.

Typically the method includes, in the one or more electronic processing devices, displaying an indication of the changes to allow a user to select reports for updating.

Typically the method includes, in the one or more electronic processing devices, comparing acquired updated report to the workspace corporate data to identify duplicate reports.

Typically the method includes, in the one or more electronic processing devices, recording an indication of acquired updated reports.

Typically the workspace corporate data includes one or more reports relating to one more entities and wherein the method includes, in the one or more electronic processing devices:
a) determining at least one selected entity in accordance with input commands from a user;
b) performing a search associated with the at least one selected entity to identify at least one report associated with the entity; and,
c) selectively acquiring the report in accordance with user input commands.

Typically the method includes, in the one or more electronic processing devices:
a) determining an entity type associated with the at least one selected entity; and,
b) performing the search at least partially in accordance with the entity type.

Typically the method includes, in the one or more electronic processing devices performing a search of one or more report sources.

Typically the method includes, in the one or more electronic processing devices:
a) determining search rules; and,
b) performing the search at least partially in accordance with the search rules.

Typically the method includes, in the one or more electronic processing devices:
a) determining search parameters associated with the search at least partially in accordance with at least one of:
   i) search rules;
   ii) input commands from a user; and,
   iii) a report source;
b) generating the search in accordance with the search parameters.

Typically the method includes, in the one or more electronic processing devices:
a) displaying search results indicative of available reports; and,
b) determining a report to be acquired in accordance with user input commands.

Typically the method includes, in the one or more electronic processing devices:
a) determining a report to be acquired in accordance with user input commands;
b) identifying a report source associated with the report to be acquired;
c) generating a report request in accordance with the report source; and,
d) transferring the report request to the report source, the report source being responsive to the report request to provide the report.

Typically the method includes, in the one or more electronic processing devices:
a) determining report parameters associated with the report request in accordance with input commands from a user; and,
b) generating the report request in accordance with the selected report parameters.

Typically the method includes, in the one or more electronic processing devices:
a) determining available report parameters from at least one of report rules and the report source; and,
b) displaying an indication of the available report parameters the user being responsive to the displayed available report parameters to provide the report parameters.

Typically the method includes, in the one or more electronic processing devices:
a) determining report rules in accordance with the report source; and,
b) generating the report request in accordance with the report rules.

Typically the method includes, in the one or more electronic processing devices, generating a network representation, wherein the network representation includes:
a) a number of nodes, each node being indicative of a corresponding entity; and,
b) a number of connections between nodes, the connections being indicative of relationships between the entities.

Typically the method includes, in the one or more electronic processing devices, modifying the representation by at least one of:
a) replacing multiple connections and associated nodes with a single connection and node;
b) replacing multiple connections of a common connection type with a single connection;
c) by replacing multiple nodes of matching entities with a single node; and,
d) selectively hiding at least one of the nodes and the connections.

Typically the method includes, in the one or more electronic processing devices:
a) identifying a respective plurality of connections having a common connection type for each of a number of connection types;
b) replacing each plurality of connections with a single connection; and,
c) replacing nodes at each end of each of the plurality of connections with a respective single node.

Typically the method includes, in the one or more electronic processing devices:
a) determining a selected connection type in accordance with input commands from a user;
b) identifying a plurality of connections having the selected connection type;
c) replacing the plurality of connections with a single connection; and,
d) replacing nodes at each end of each of the plurality of connections with a respective single node.

Typically the method includes, in the one or more electronic processing devices:
a) determining matching entities; and,
b) modifying the network representation by merging nodes associated with the matching entities.

Typically the method includes, in the one or more electronic processing devices, determining the matching entities based on at least one of:
a) input commands from a user;
b) entity type; and,
c) entity parameters.

Typically the method includes, in the one or more electronic processing devices, determining a pair of entities to be matching entities by:
a) comparing the entity types of the pair of entities; and,
b) in response to a successful comparison, comparing entity parameters of each entity.

Typically the entity parameters include entity parameters, and wherein the method includes, in the one or more electronic processing devices:
a) selecting entity parameters for comparison using rules;
b) comparing the entity parameters to determine if they match; and,
c) in response to a successful comparison, at least one of:
   i) selecting more entity parameters; and,
   ii) determining the entities to be equivalent.

Typically the method includes, in the one or more electronic processing devices, comparing the entity parameters using at least one of:
a) distance matching techniques; and,
b) fuzzy logic.

Typically the method includes, in the one or more electronic processing devices, generating a second network representation including a report as a respective node in the representation.

Typically the method includes, in the one or more electronic processing devices:
a) determining at least one connection type in accordance with input commands from a user;
b) identifying connections having the at least one connection type;
c) identifying nodes associated with the at least one connection type; and,
d) selectively hiding identified connections and nodes in accordance with input commands from a user.

In one broad form the present invention seeks to provide a method of managing corporate data, the corporate data includes one or more reports relating to one more entities, the method including, in one or more electronic processing devices:
a) comparing at least some report details of each report to at least some report details from a report source;
b) identifying changes in reports in response to results of the comparison;
c) displaying an indication of the changes;
d) determining at least one selected report for updating in accordance with input commands from a user; and,
e) updating the at least one report by acquiring an updated report from the report source.

In one broad form the present invention seeks to provide a method of managing corporate data, the corporate data including one or more reports relating to one more entities, the method including, in one or more electronic processing devices:
a) determining at least one selected entity in accordance with input commands from a user;
b) performing a search of one or more report sources, the search being at least partially associated with the at least one selected entity and being performed at least partially in accordance with search rules, to thereby identify at least one report associated with the entity; and,
c) selectively acquiring the report in accordance with user input commands.

In one broad form the present invention seeks to provide a method of managing corporate data, the corporate data including one or more reports relating to one more entities, the method including, in one or more electronic processing devices:
a) determining a report to be acquired in accordance with user input commands;
b) identifying a report source associated with the report to be acquired;
c) generating a report request in accordance with report rules associated with the report; and,
d) transferring the report request to the report source, the report source being responsive to the report request to provide the report.

In one broad form the present invention seeks to provide a method of managing corporate data, the corporate data including one or more reports relating to one more entities, the method including, in one or more electronic processing devices:
a) generating a network representation, wherein the network representation includes:
   i) a number of nodes, each node being indicative of a corresponding entity; and,
   ii) a number of connections between nodes, the connections being indicative of relationships between the entities; and,
b) modifying the representation by at least one of:
   i) combining multiple connections and associated nodes into a single connection and corresponding nodes;
   ii) combining multiple connections of a common connection type into a single connection;
   iii) combining multiple nodes of matching entities into a single node; and,
   iv) selectively hiding at least one of the nodes and/or the connections.

In one broad form the present invention seeks to provide apparatus for managing corporate data, the apparatus including in one or more electronic processing devices that:
a) host a workspace associated with workspace corporate data;
b) provide users access to the workspace in accordance with user access permissions to thereby allow the users to perform actions relating to the workspace corporate data, the actions including at least one of:
   i) selecting workspace corporate data to be acquired from one or more corporate data sources;
   ii) viewing the workspace corporate data;
   iii) manipulating the workspace corporate data; and,
   iv) updating the workspace corporate data.

In one broad form the present invention seeks to provide apparatus for managing corporate data, the corporate data includes one or more reports relating to one more entities, the apparatus including one or more electronic processing devices that:
a) compare at least some report details of each report to at least some report details from a report source;
b) identify changes in reports in response to results of the comparison;
c) display an indication of the changes;
d) determine at least one selected report for updating in accordance with input commands from a user; and,
e) update the at least one report by acquiring an updated report from the report source.

In one broad form the present invention seeks to provide apparatus for managing corporate data, the corporate data including one or more reports relating to one more entities, the apparatus including one or more electronic processing devices that:
a) determine at least one selected entity in accordance with input commands from a user;
b) perform a search of one or more report sources, the search being at least partially associated with the at least one selected entity and being performed at least partially in accordance with search rules, to thereby identify at least one report associated with the entity; and,
c) selectively acquire the report in accordance with user input commands.

In one broad form the present invention seeks to provide apparatus for managing corporate data, the corporate data including one or more reports relating to one more entities, the apparatus including one or more electronic processing devices that:
a) determine a report to be acquired in accordance with user input commands;
b) identify a report source associated with the report to be acquired;
c) generate a report request in accordance with report rules associated with the report; and,
d) transfer the report request to the report source, the report source being responsive to the report request to provide the report.

In one broad form the present invention seeks to provide apparatus for managing corporate data, the corporate data including one or more reports relating to one more entities, the apparatus including one or more electronic processing devices that:
a) generate a network representation, wherein the network representation includes:
   i) a number of nodes, each node being indicative of a corresponding entity; and,
   ii) a number of connections between nodes, the connections being indicative of relationships between the entities; and,
b) modify the representation by at least one of:
   i) combining multiple connections and associated nodes into a single connection and corresponding nodes;
   ii) combining multiple connections of a common connection type into a single connection;
   iii) combining multiple nodes of matching entities into a single node; and,
   iv) selectively hiding at least one of the nodes and/or the connections.

It will be appreciated that the broad forms of the invention can be used independently, or in conjunction and that features of the broad forms can be used interchangeably.

### BRIEF DESCRIPTION OF THE DRAWINGS

An example of the present invention will now be described with reference to the accompanying drawings, in which:—

FIG. 1A is a flowchart of an example of a method of managing corporate data using a workspace;

FIG. 1B is a flowchart of an example of a method of managing corporate data by searching reports;

FIG. 1C is a flowchart of an example of a method of managing corporate data by updating reports;

FIG. 1D is a flowchart of an example of a method of managing corporate data by acquiring reports;

FIG. 1E is a flowchart of an example of a method of managing corporate data by generating network representations;

FIG. 1F is a schematic diagram of an example of a network representation;

FIG. 2 is a schematic diagram of an example of a distributed computer architecture;

FIG. 3 is a schematic diagram of an example of a processing system of FIG. 2;

FIG. 4 is a schematic diagram of an example of a computer system of FIG. 2;

FIGS. 5A and 5B are a flowchart of an example of a process for creating and sharing a workspace;

FIG. 6 is a schematic diagram of an example of a user interface used in the method of FIGS. 5A and 5B;

FIG. 7 is a flowchart of an example of a workflow utilising the workspace;

FIG. 8 is a flowchart of an example of a method of updating reports in a workspace;

FIGS. 9A to 9D are schematic diagrams of examples of the user interface used in the method of FIG. 8;

FIG. 10 is a flowchart of an example of a method of performing a search;

FIGS. 11A and 11B are schematic diagrams of examples of user interfaces used in the method of FIG. 10;

FIG. 12 is a flowchart of an example of a method of acquiring a report;

FIGS. 13A and 13B are schematic diagrams of an example of user interfaces used in the method of FIG. 12;

FIG. 14 is a flowchart of an example process for combining connections in the network representation;

FIGS. 15A to 15D are schematic diagrams of examples of user interfaces used in the method of FIG. 14;

FIGS. 16A and 16B are a flowchart of an example of a method of matching entities;

FIGS. 17A to 17C are schematic diagrams of examples of user interfaces used in the method of FIGS. 16A and 16B;

FIG. 18 is a flowchart of an example process for filtering nodes or connections in network representations;

FIGS. 19A to 19K are schematic diagrams of examples of user interfaces used in the method of FIG. 18; and,

FIG. 20 is a schematic diagram of an example of a second network representation.

### DETAILED DESCRIPTION OF THE PREFERRED EMBODIMENTS

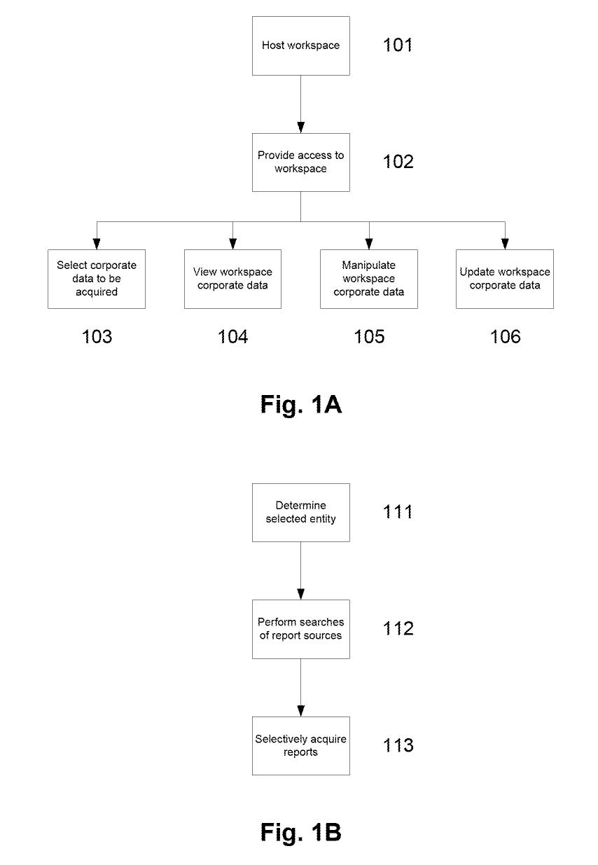

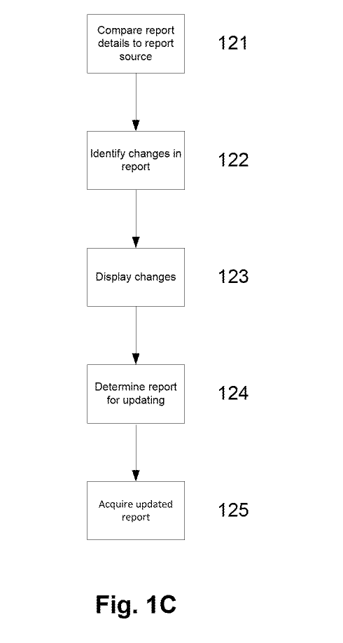

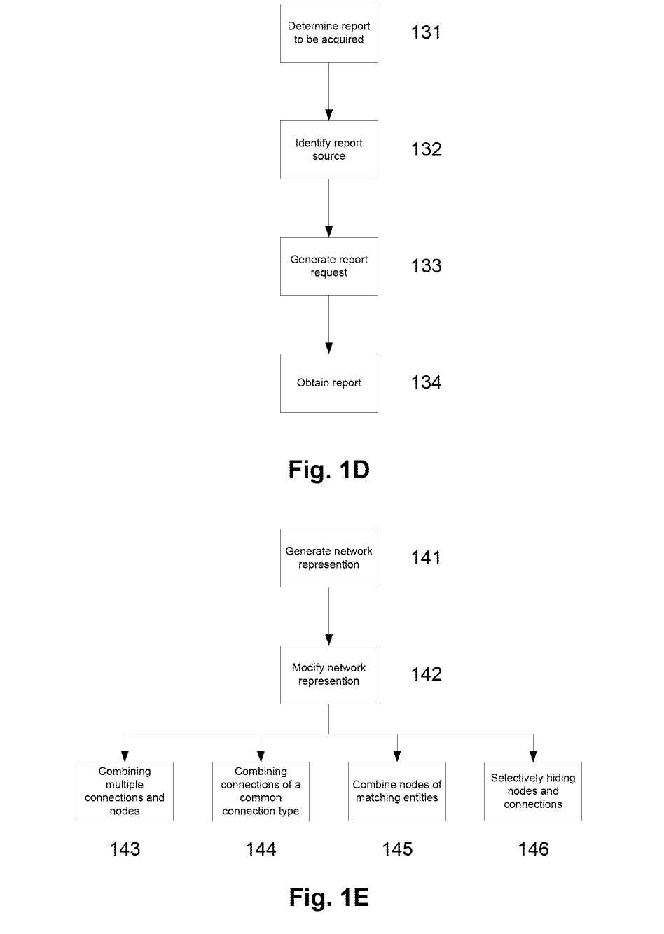

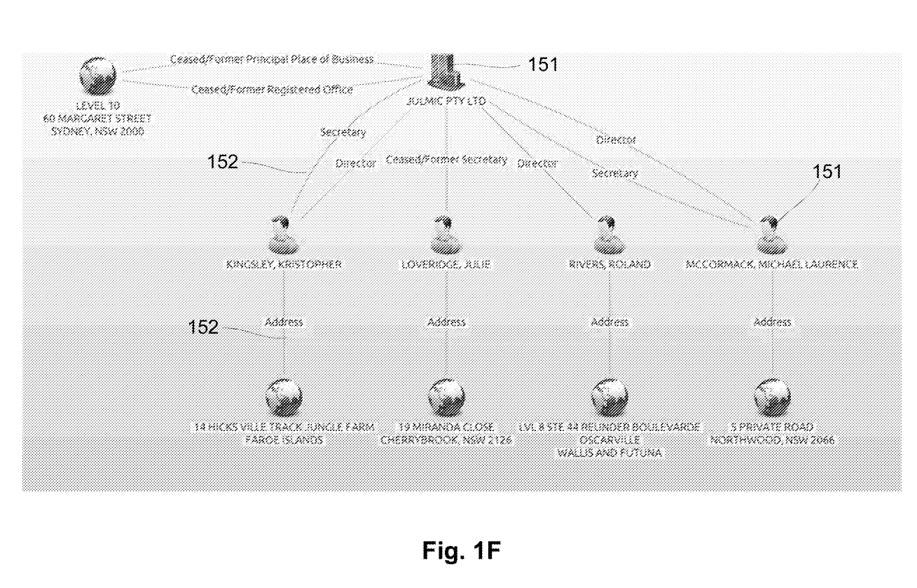

Examples of processes for managing corporate data will now be described with reference to FIGS. 1A to 1F.

In this example, it is assumed that the process is performed at least in part using one or more electronic processing devices forming part of one or more processing systems, which are in turn connected to one or more other computer systems via a network architecture, as will be described in more detail below.

For the purpose of example, the following terminology will be used.

The term “user” is used to refer to an individual that is interacting with the processing system, for example to view corporate data. The term “corporate data” refers to information relating to one or more corporate entities, such as companies, real estate, persons or individuals within companies, as well as to relationships between and properties of, the entities, optionally with a specific focus on company structure, real estate ownership and financial status. The corporate data can be obtained from commercial reports and may be created on demand from an underlying information source such as a company regulator, who typically holds the underlying information in a semi-structured form such as that provided by XML (eXtensible Markup Language).

The term “workspace” refers to a collection of computer based and optionally network based resources, which collectively define an environment that can be accessed via one or more user interfaces, and in which users can interact with corporate data. The workspace is therefore typically defined at least in part by storage capabilities, allowing corporate and optionally other data to be stored, as well as interfaces that allow for access to the corporate data and software tools for manipulating the corporate data. The term “workspace corporate data” refers to corporate data within a respective workspace.

A “network representation” or “network chart” is visual representation of a network (business, social, criminal, . . . ) showing the relationships as a graph with the nodes representing the entities (Person, organization, event, . . . ) and the links the different types of relationship (parent of, director, associate, . . . )

FIG. 1A describes a method of managing corporate data via a workspace.

In this example, at step 101 the one or more electronic processing devices host a workspace associated with workspace corporate data. The workspace corporate data can be of any appropriate form, but typically includes data relating to one or more corporate entities and their inter-relationships, and in one particular example is derived from reports obtained from a number of different report sources.

At step 102, the one or more processing systems provide users access to the workspace in accordance with user access permissions to thereby allow the users to perform actions relating to the workspace corporate data. The actions typically include at least one of selecting workspace corporate data to be acquired from one or more corporate data sources at step 103, viewing the workspace corporate data at step 104, manipulating the workspace corporate data at step 105 and updating the workspace corporate data at step 106. The user access permission can be used to control which users can access and view a particular workspace, as well as controlling which actions each individual can perform.

Accordingly, the use of the workspace can allow a number of different users to centrally access common corporate data, and then interact with the corporate data, allowing the corporate data to be reviewed and manipulated as required. This, in turn, allows a number of users to collectively work on workspace corporate data, in accordance with existing organizational workflows, thereby allowing for efficient creation of corporate data reports.

A number of example processes that can be performed will now be described in more detail.

A method of managing corporate data will now be described with reference to FIG. 1B, which allows for users to perform searches of the corporate data.

In this example, at step 111, the one or more electronic processing devices determine at least one selected entity in accordance with input commands from a user. This can be achieved in any suitable manner, such as displaying a list of entities, allowing one of these to be selected by a user. More typically this involves displaying a network representation, as will be described in more detail below, with the user being able to select one or more of the entities displayed on the network representation.

At step 112, the one or more electronic processing devices perform a search of one or more report sources, the search being at least partially associated with the, at least one selected entity and being performed, at least partially in accordance with search rules, to thereby identify at least one report associated with the entity. Thus, search rules can be defined, for example based on a type of the entity, with the one or more processing systems accessing the search rules and using these to generate appropriate queries suited to the report source to identify reports associated with the entity.

At step 113, the one or more electronic process devices selectively acquire the report in accordance with user input commands. This can be used for example to enable additional information regarding the entity to be obtained, or to allow existing information to be updated. For example, and as will be described in more detail below, this allows a user to identify which previously acquired reports have been changed in the report source and allow them to acquire a new copy. So, unlike a search engine where there is an implicit assumption that data once retrieved is unchangeable, this can manages the possibility that the information has changed, and allow the workspace corporate data to be updated.

A method for updating reports will now be described with reference to FIG. 1C.

In this example, at step 121, the one or more electronic processing devices compare at least some report details of each report in the workspace to at least some report details from a report source. This can be achieved in any suitable manner, but in one example involves querying report sources to obtain details of equivalent reports, such as dates of the most recent report update, or the like.

At step 122, the result of the comparison is used to identify changes in reports, with an indication of the changes being displayed at step 123. Accordingly, this allows a user to view the changes and ascertain whether the workspace corporate data needs updating.

At step 124, at least one selected report for updating is determined in accordance with input commands from a user, with the one or more processing devices operating to update the report by acquiring an updated report from the report source at step 125.

Accordingly, it will be appreciated that this allows reports to be updated substantially automatically, requiring only manual approval of the updating process.

An example of the method for acquiring a report will now be described in more detail with reference to FIG. 1D.

In this example, at step 131 the one or more processing systems can determine a report to be acquired at least partially in accordance with user input commands. Thus, it will be appreciated that this could be achieved for example, by performing a search using the manner described above with respect to FIG. 1B or determining a report to be updated in FIG. 1C.

At step 132, the one or more processing systems identify a report source associated with the report to be acquired. The report source is typically a publically accessible repository, and details of the source can therefore be obtained from public sources, and stored, for example, in metadata in the workspace, in search rules, or the like.

At step 133, the one or more processing systems can generate a report request in accordance with report rules associated with the report. The report rules can be of any appropriate form, but typically define the interactions that need to be performed to interact with report source to allow the report to be acquired and where necessary transformed back from its structured form into a more easily assimilated textual report.

At step 134, the one or more processing systems transfer the report request to the report source, the report source being responsive to the report request to provide the report.

Accordingly, this provides a mechanism to substantially automate the process for obtaining reports, thereby minimising the user involvement required.

An example of a method of managing corporate data by displaying a network representation will now be described with reference to FIGS. 1E and 1F.

In this example, at step 141, the method includes generating a network representation which includes a number of nodes 151, each node being indicative of a corresponding entity and a number of connections 152 between nodes, the connections being indicative of relationships between the entities. The network representation can be generated in any suitable manner, but typically involves determining the entities that are to be displayed, determining the relationships between the entities, and then arranging the entities as nodes on the representation. This can be performed using known layout techniques, as would be appreciated by a person skilled in the art.

At step 142, the one or more processing systems modify the representation by at least one of: replacing multiple connections and associated nodes with a single connection and node at step 143, replacing multiple connections of a common connection type with a single connection at step 144, replacing multiple nodes of merged entities with a single node at step 145 and selectively hiding at least one of the nodes and/or the connections at step 146. As part of this process, the layout of the representation may be updated, although this is not essential and will depend on the preferred implementation.

The ability to manipulate the representation and in particular combine and/or hide connections and nodes, allows the amount of features in the network representation to be reduced, whilst still retaining the basic information, making the network representation easier to understand and interpret.

Accordingly the above described techniques can be used independently, and/or in conjunction, to assist users in managing corporate data.

A number of further features will now be described.

In one example, the method includes, in the one or more electronic processing devices, displaying a workspace representation, the workspace representation including an indication of the workspace corporate data, one or more reports forming part of the workspace corporate data, one or more entities to which the workspace corporate data relates or a network representation of the corporate data. Thus the workspace can display the information users typically require when interacting with corporate data in a single convenient location. In one particular example, the workspace can be displayed as part of a network page, allowing this to be viewed using a browser application or similar, thereby avoiding the need for users to have access to specialist software applications, whilst also still allowing a wide range of corporate data management actions to be performed. However, this is not essential and any suitable technique can be used. The indication of the workspace corporate data can be of any suitable form and can include a name of the workspace, which can be used to identify the particular collection of corporate data, a list of the corporate data within the workspace and/or a representation of the corporate data itself, including for example a network representation, as will be described in more detail below.

The one or more electronic processing devices can generate a link indicative of a workspace address and provide the link to users to thereby allow user access to the workspace. The link can be of any suitable form, but in one example is a URL (Uniform Resource Locator), allowing a user to receive the link and easily access the workspace. The URL can be provided in any suitable manner, but in one example, the one or more electronic processing devices generate a notification including the link and transferring the notification to the user.

In one example, the one or more electronic processing devices determine, in accordance with input commands from a first user, a user identifier indicative of an identity of a second user permitted to access the workspace and record an indication of the second user identifier as part of user data associated with the workspace. This allows a first user to authorize a second user to access the workspace. Following this, the link can be forwarded to the second user, allowing the user to access the workspace.

Additionally, the one or more electronic processing devices determine, in accordance with input commands from the first user, user permissions associated with the second user, the user permissions being indicative of actions the second user can perform and record an indication of the user permissions as part of the user data. Thus, not only can the first user grant access to the second user, but can also control the actions the second user can perform, for example, to prevent the second user overwriting corporate data, ordering and paying for new or updated reports, or the like.

In this example, the one or more electronic processing devices can receive a share workspace request from the first user, display a list of potential users and determine the user identifier of the second user in accordance with selection of a potential user from the list of users. In one example, the processing devices interface with existing corporate user information, allowing this to be displayed to the first user, to thereby facilitate the process of authorizing the second user. Alternatively however, the first user may supply the user identifier indicative of the second user manually. The user identifier could be in any suitable form, such as name, user name, email address, or the like, as will be described in more detail below.

Furthermore, the electronic processing devices can display, as part of a workspace representation, a share workspace option and receive a share workspace request from the first user in accordance with selection of the share workspace option by the first user.

In one example, the method includes receiving a workspace access request including an indication of a user identifier, comparing the user identifier to the user data and selectively providing access to the corporate data in the workspace in accordance with the results of the comparison. Thus, this allows the processing devices to confirm a user attempting to access a workspace is authorised to do so.

The one or more electronic processing devices can also create the workspace in accordance with input commands from a user, thereby allowing the user to create new workspaces.

The one or more electronic processing devices can determine a selection of workspace corporate data to be acquired in accordance with user input commands from a first user, display the indication of the selection to a second user, acquire the corporate data in accordance with input commands from the second user and display the workspace corporate data to the first user. Thus, this allows a first user, such as a manager, to define the corporate data that is required. A second user, such as a staff member, can then perform actions that are required, such as ordering and analyzing the data, presenting the results to the first user via the workspace. Thus the workspace facilitates multiple users working corporate data in normal organization workflows.

The one or more electronic processing devices typically manipulate the workspace corporate data at least partially in accordance with user input commands, allowing users to control the process.

The one or more electronic processing devices typically determine, in accordance with input commands from a user, changes in the workspace corporate data or a representation of the workspace corporate data and record an indication of the changes together with a user identifier of the user. This allows changes to the workspace corporate data to be tracked, so that logging and change management requirements can be met, for example for auditing purposes.

The workspace corporate data typically includes one or more reports relating to one more entities, and the method typically includes identifying, from a report source, changes in the reports and selectively updating a report by acquiring an updated report from the report source in accordance with input commands from a user. Thus, this provides a mechanism for acquiring reports to thereby update the workspace corporate data.

As previously described, to determine if a report needs updating the one or more electronic processing devices can compare at least some report details of each report to at least some report details from a report source to determine changes in the reports. An indication of any changes can then be displayed to the user to allow a user to select reports for updating. As part of this process, the method can include using information regarding the rate at which reports are updated within a report source to provide the user with estimates of the likelihood of change for an individual report. For example, if a report source only updates data on a weekly basis, or if it is calculated from observation that the mean time between report updates in 8 weeks, it may not be worthwhile checking the report source daily to determine if reports have changed.

Once reports have been acquired, these can be compared to the workspace corporate data to identify duplicate reports and/or entities. An indication of acquired updated reports can be stored, again allow changes to be subsequently reviewed and tracked for auditing or the like.

In one example, the one or more electronic processing devices determine at least one selected entity in accordance with input commands from a user, perform a search associated with the at least one selected entity to identify at least one report associated with the entity and selectively acquire the report in accordance with user input commands. Typically an entity type associated with the at least one selected entity is determined, with the search being performed at least partially in accordance with the entity type. The search is typically of one or more report sources and is usually performed using search rules. Thus, the sources and search rules can, for example, be selected based on the type of entity, so that the search is appropriate for the type of entity being investigated. In one particular example, search parameters associated with the search are determined based on search rules, input commands from a user or a report source, with the search being generated in accordance with the search parameters.

The method typically includes displaying search results indicative of available reports and determining a report to be acquired in accordance with user input commands. Thus, it will be appreciated that the searching process can be performed in order to identify additional reports to be acquired.

Once a report to be acquired has been identified, a report source associated with the report can be identified, with this being used to generate a report request in accordance with the report source and transfer the report request to the report source, the report source being responsive to the report request to provide the report.

In this instance, the process would typically involve determining report parameters associated with the report request in accordance with input commands from a user and generating the report request in accordance with the selected report parameters. Available report parameters can be determined from at least one of report rules and the report source and then displayed to the user, allowing the user to provide the report parameters. This can include providing values, such as entity names or the like, as well as selecting information to be included in the report, as will be described in more detail below.

Report rules can then be determined in accordance with the report source and used to generate a report request, which is transferred to the report source to allow the report to be provided. The report rules can specify the nature of the report request and can be generated using suitable techniques, such as scripts or the like, thereby allowing ordering of the reports to be performed in a substantially automated fashion.

As previously mentioned, a network representation is typically generated which includes a number of nodes, each node being indicative of a corresponding entity and a number of connections between nodes, the connections being indicative of relationships between the entities.

As the network representations can be very complex when a number of different entities are involved, it is preferable to be able to modify the representation by replacing multiple connections and associated nodes with a single connection and node, replacing multiple connections of a common connection type with a single connection, replacing multiple nodes of matching entities with a single node or selectively hiding nodes and/or the connections. This can be achieved using a variety of techniques.

For example, it is possible to identify a respective plurality of connections having a common connection type for each of a number of connection types, replace each plurality of connections with a single connection and then replace nodes at each end of each of the plurality of connections with a respective single node. This effectively combines all connections that have a common connection type and combines the corresponding nodes, so that each connection type is represented by a single connection. Additionally and/or alternatively, a selected connection type can be determined in accordance with input commands from a user, allowing connections of a single connection type to be combined. Thus, instead of combining all connections, only those of a specified type are combined. Combined connections can also be expanded using similar techniques.

In another example, it is possible to determine matching entities and modify the network representation by merging nodes associated with the matching entities. In this example, matching entities can be determined based on any one or more of input commands from a user, an entity type or entity parameters. In particular, entities are typically determined to be matching by comparing the entity types of the pair of entities and in response to a successful comparison, comparing entity parameters of each entity. This process typically involves selecting entity parameters for comparison using matching rules, comparing the entity parameters to determine if they match and in response to a successful comparison, selecting further entity parameters or determining the entities to be equivalent. The entity parameters can be compared using any suitable technique, such as direct comparison, distance or pattern matching techniques, fuzzy logic, or the like.

Furthermore, it is possible to hide or unhide connections, for example by determining at least one connection type in accordance with input commands from a user, identifying connections having the at least one connection type, identifying nodes associated with the at least one connection type and selectively hiding identified connections and/or nodes in accordance with input commands from a user.

A further option is to generate a second network representation including a group of nodes corresponding to a respective report in the representation, as will be described in more detail below.

In any event, it will be appreciated that a variety of techniques can be used to simplify the network representations and make the corporate data easier to update and review.

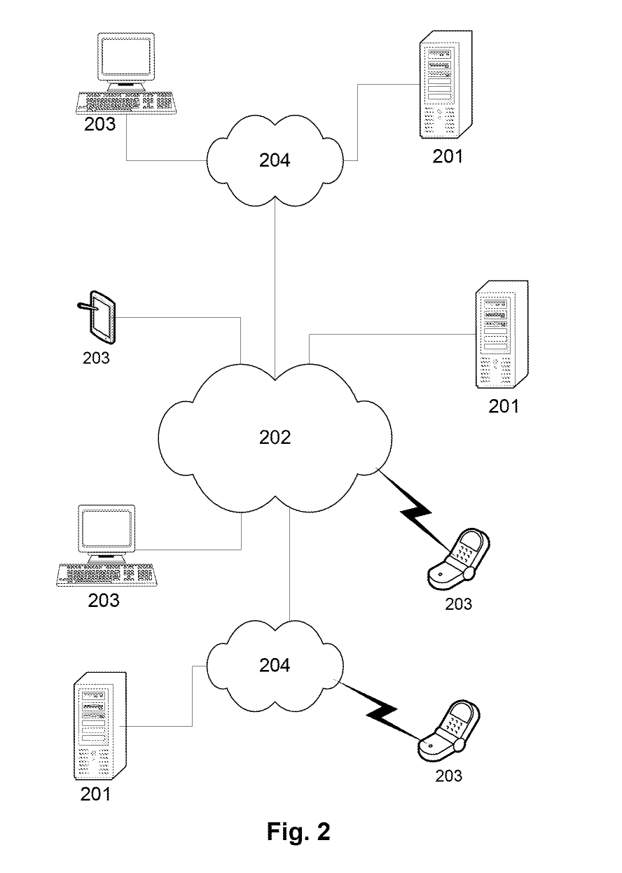

In one example, the process is performed by one or more processing systems operating as part of a distributed architecture, an example of which will now be described with reference to FIG. 2.

In this example, a base station 201 is coupled via a communications network, such as the Internet 202, and/or a number of local area networks (LANs) 204, to a number of computer systems 203. It will be appreciated that the configuration of the networks 202, 204 are for the purpose of example only, and in practice the base station 201 and computer systems 203 can communicate via any appropriate mechanism, such as via wired or wireless connections, including, but not limited to mobile networks, private networks, such as 802.11 networks, the Internet, LANs, WANs, or the like, as well as via direct or point-to-point connections, such as Bluetooth, or the like.

In one example, the base station 201 includes one or more processing systems 210 coupled to a database 211. The base station 201 is adapted to be used in centrally managing corporate data, and in particular hosting workspaces and analysing the corporate data. The computer systems 203 are adapted to communicate with the base station 201, allowing users to interact with the workspaces and workspace corporate data.

Whilst the base station 201 is a shown as a single entity, it will be appreciated that the base station 201 can be distributed over a number of geographically separate locations, for example by using processing systems 210 and/or databases 211 that are provided as part of a distributed or cloud based environment. However, the above described arrangement is not essential and other suitable configurations could be used.

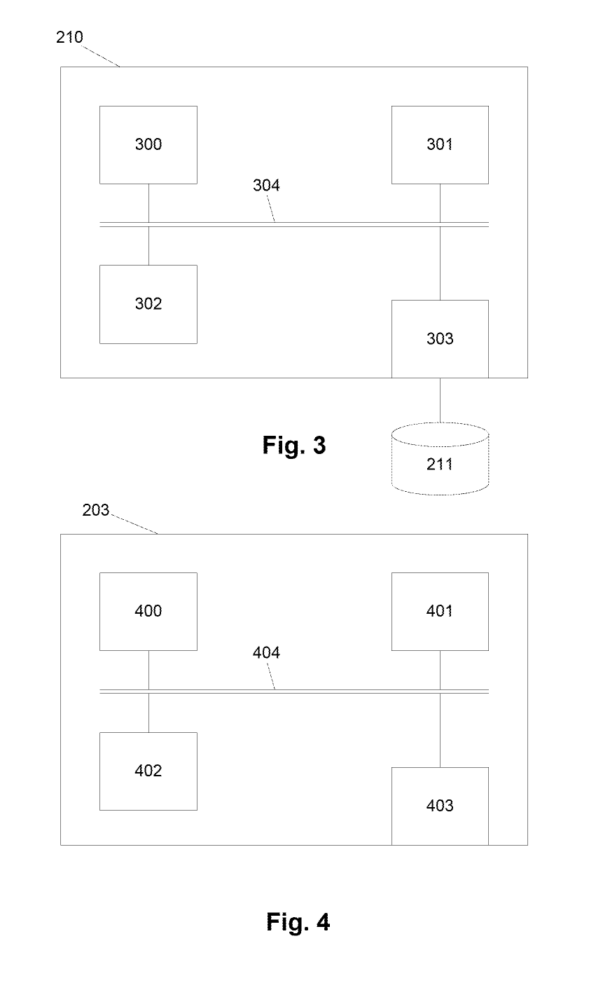

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 202, 204, databases 211, other storage devices, or the like. Although a single external interface 303 is shown, this is for the purpose of example only, and in practice multiple interfaces using various methods (eg. Ethernet, serial, USB, wireless or the like) may be provided.

In use, the microprocessor 300 executes instructions in the form of applications software stored in the memory 301 to allow the workspace to be created and hosted, as well as allowing for interaction with the workspace corporate data, and optionally searching and acquiring reports from remote sources, typically in the form of report servers (not shown). The applications software may include one or more software modules, and may be executed in a suitable execution environment, such as an operating system environment, or the like.

Accordingly, it will be appreciated that the processing system 210 may be formed from any suitable processing system, such as a suitably programmed computer system, PC, web server, network server, or the like. In one particular example, the processing system 210 is a standard processing system such as an Intel or AMD Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the computer system 203 includes at least one microprocessor 400, a memory 401, an input/output device 402, such as a keyboard and/or display, and an external interface 403, interconnected via a bus 404 as shown. In this example the external interface 403 can be utilised for connecting the computer system 203 to peripheral devices, such as the communications networks 202, 204, storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401 to allow communication with the base station 201, for example to allow users to interact with workspace corporate data, manage acquisition of new corporate data or the like.

Accordingly, it will be appreciated that the computer systems 203 may be formed from any suitable processing system, such as a suitably programmed PC, Internet terminal, lap-top, hand-held PC, smart phone, PDA, web server, or the like. Thus, in one example, the processing system 210 is a standard processing system such as an Intel or AMD Architecture based processing system, which executes software applications stored on non-volatile (e.g., hard disk) storage, although this is not essential. However, it will also be understood that the computer systems 203 can be any electronic processing device such as a microprocessor, microchip processor, logic gate configuration, firmware optionally associated with implementing logic such as an FPGA (Field Programmable Gate Array), or any other electronic device, system or arrangement.

Examples of the corporate data management processes will now be described in further detail. For the purpose of these examples, it is assumed that the processing system 210 is a network server that interacts with or is part of an organisation's internal architecture, allowing authentication to be performed by the organisation. For example, an organisation may maintain a single organisation account with the processing system 210, with employees or members of the organisation being granted access rights, as will be described in more detail below. It is also assumed that the processing system 210 hosts network pages allowing the organisation's users to access workspaces, although this is not essential and this can alternatively be performed using suitable enterprise software.

Thus the one or more processing systems 210 of the base station 201 typically execute applications software for hosting workspaces, with actions performed by each processing system 210 being performed by the processor 300 in accordance with instructions stored as applications software in the memory 301 and/or input commands received from a user via the I/O device 302, or commands received from the computer system 203.

It will also be assumed that the user interacts with the processing systems 210 via a GUI (Graphical User Interface), or the like presented on the computer system 203, and in one particular example via a browser application that displays network pages hosted by the base station 201. Actions performed by the computer system 203 are performed by the processor 401 in accordance with instructions stored as applications software in the memory 402 and/or input commands received from a user via the I/O device 403.

However, it will be appreciated that the above described configuration assumed for the purpose of the following examples is not essential, and numerous other configurations may be used. It will also be appreciated that the partitioning of functionality between the computer systems 203, and the base station 201 may vary, depending on the particular implementation.

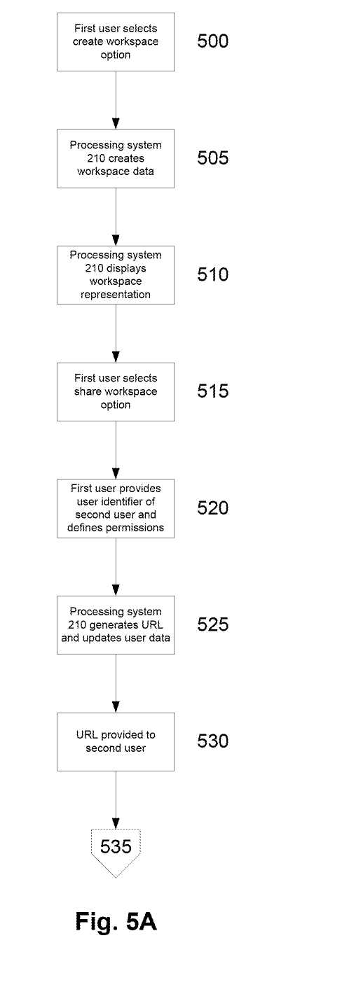

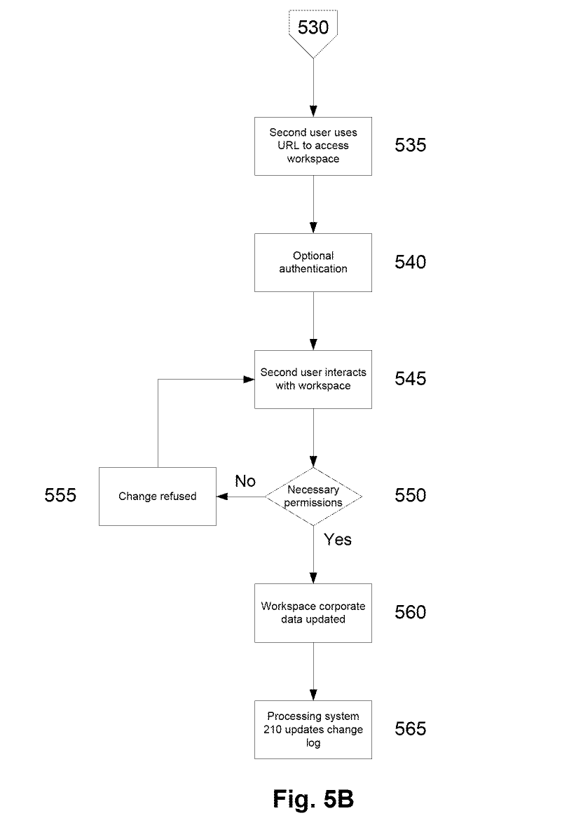

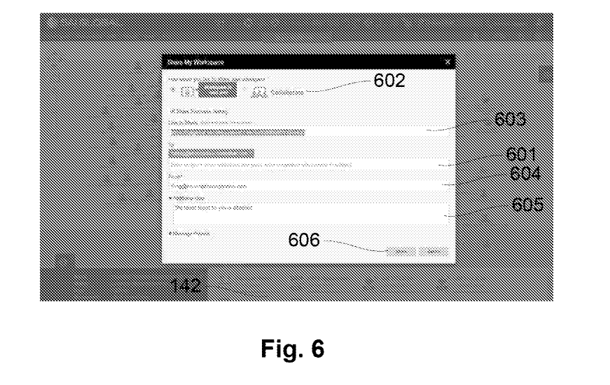

An example of the process for creating a workspace will now be described with reference to FIGS. 5A and 5B and FIG. 6.

In this example, at step 500 a first user selects a create workspace option, for example displayed on a network page hosted by the processing system 210. It will be appreciated that as part of this process, the first user may need to access the processing system 210 and undergo authentication or like. In one example, access to the network page by the processing system 210 is via a corporate network in which case the user may undergo authentication on the corporate network with servers on the corporate network in turn undergoing authentication with the processing system 210.

At step 505 the processing system 210 creates workspace data relating to the new workspace. The workspace data may include information such as a user identifier of the first user, a workspace name, date of creation or change log, or the like, acting as evidence of who created the workspace for auditing purposes. At this stage the first user may also specify additional information regarding the intended content of the workspace, such as the nature of reports and/or entities of interest, although alternatively this can be performed as a separate subsequent process as will be described in more detail below.

At step 510, the processing system 210 typically displays a workspace representation as part of a user interface. It will be appreciated that at this stage, if no further actions have been performed, this will typically be in the form of a basic interface with no populated data but basic controls corresponding to actions the first user can perform.

At step 515, the first user selects a share workspace option, which is utilised in order to allow for sharing of the workspace with other users. A single share workspace option may be provided or alternatively different options may be provided corresponding to different levels of permissions, such as sharing or collaboration, or the like.

At step 520 the first user provides a user identifier of one or more second users and optionally defines permissions associated with these users. This can be achieved in any appropriate manner, and in one example would involve having the processing system 210 display details of known users of the system, allowing the first user to select other ones of the known users as second users. Alternatively, the first user could manually enter a user identifier of the second user, such as an email address or the like, using an appropriate interface.

As mentioned above, the user permission may be defined by selecting an appropriate shared workspace option or alternatively may be defined in other manners, such as by allowing the first user to select different types of user permissions from a dropdown list, or alternatively define individual actions that users can perform. In this regard, each set of permissions will typically correspond to a respective combination of actions, such as read only, read and write, read and manipulate, or full access.

At step 525 the processing system 210 generates a URL and updates user data with details of the second user identifier and the associate permissions. An example of the user interface displayed by the computer system 203 of the first user is shown in FIG. 6. In this example, the interface includes a second user identifier in the form of a recipient email address 601, the permissions 602 and the URL for sharing 603. Additionally, an indication of the first user identifier of the first user sending the share request can be provided at 604 and optionally notes may be added in an appropriate note field 605, for example to provide instructions to the second user regarding tasks they need to perform.

Once this information has been provided, the user can select a share option 606, at which point the URL is provided to the second user, for example by generating a notification such as an email or the like, which is sent to the second user at step 530.

At step 535 the second user can use the URL to access the workspace. As previously mentioned the workspace is typically in the form of a network page hosted by the processing system 210 and accordingly, by selecting the URL utilising an appropriate software application, this can automatically open the network page on the second user's computer system 203. Alternatively, the URL could be copied and pasted into an address bar or the like.

At step 540 the second user may be required to accept terms and conditions and undergo optional authentication, for example by having them enter a user name such as an email address and/or password or the like. Alternatively, this may not be required, for example, in the event that they have already undergone authentication within a corporate infrastructure.

At step 545 the second user optionally interacts with the workspace, for example by selecting to view or modify existing workspace corporate data, or acquire new corporate data to be integrated into the workspace corporate data. At step 550 the processing system 210 determines if the second user has the necessary permissions and if not the interaction is refused at step 555. Otherwise, the interaction is performed, with the workspace corporate data being updated as required at step 560.

At step 565, the processing system 210 operates to update a change log, which typically forms part of the workspace data. This will typically involve recording an indication of the second user identifier, as well as other relevant information, such as the date or time on which the interaction occurred, the nature of the interaction and the changes made to the corporate data, and is utilised in order to allow changes to the workspace to be tracked for auditing purposes or the like.

It will also be appreciated that additional processes could be performed in a similar manner, such as deleting or renaming workspaces, modifying access permissions of users, removing users, or the like, and these will not therefore be described in detail. In the above example, the first user could be an administrator, manager or the like, with the second user being any user authorised to access the workspace by the first user.

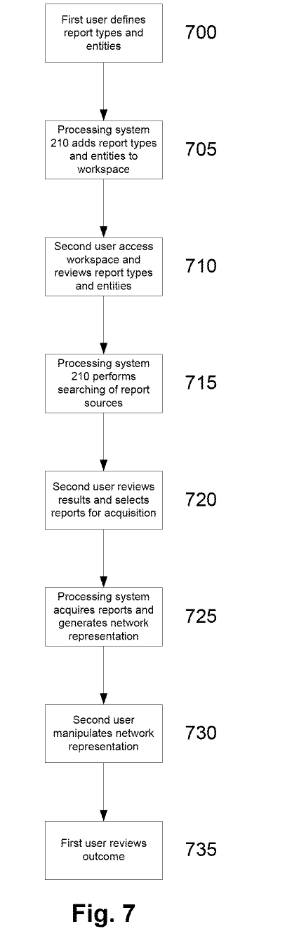

An example of the manner in which the workspace can be used will now be described with reference to FIG. 7.

In this example, a first user, such as a manager, defines report types and entities of interest. This is performed by having the first user access the workspace, select from a list of available report types, and provide details of the entities, with this being saved in the workspace as part of the workspace data, by the processing system 210.

At step 710, the second user accesses the workspace and reviews the report types and entities defined by the first user. This can be performed in any suitable manner and may occur as part of the normal workflow of the business. For example, the manager may instruct a junior member of staff to access the workspace and order the specified reports. Additionally, and/or alternatively access can be provided by having the workspace generate a notification which is provided to the second user, for example in the notes field when share access to the workspace, as described above.

At step 715 the processing system 210 performs searching of report sources in accordance with input commands provided by the second user. Thus the second user interacts with the workspace to causes searches to be performed of various report sources in a process that will be described in more detail below. This allows various available reports to be identified, with the results of the search then being reviewed by the second user, allowing the second user to select reports for acquisition at step 720.

At step 725 the processing system 210 acquires reports in accordance with input commands provided by the second user and then generates a network representation similar to the network presentation shown in FIG. 1E. The second user then typically interacts with the network representation to manipulate this into a form that is suitable for presentation. This can include combining, expanding, hiding or unhiding nodes or connections, deleting or merging nodes or the like and is preformed to make sure the network representation is manageable for its intended use. Thus, extraneous information is hidden, so that only information of interest is displayed. The hidden information is available for unforeseen situations.

At step 735 the first user is then able to review the outcome, for example by having the network presentation and associated information forwarded to them, printed and presented to them or by accessing the workspace.

Accordingly, it will be appreciated that the workspace represents a centralised location in which corporate data can be acquired, stored, reviewed and manipulated allow this to be used in producing reports including network representations that can be used in an appropriate manner. In particular, this can be used in an organisation's existing workflow procedures, thereby making the system straightforward for organisations to use.

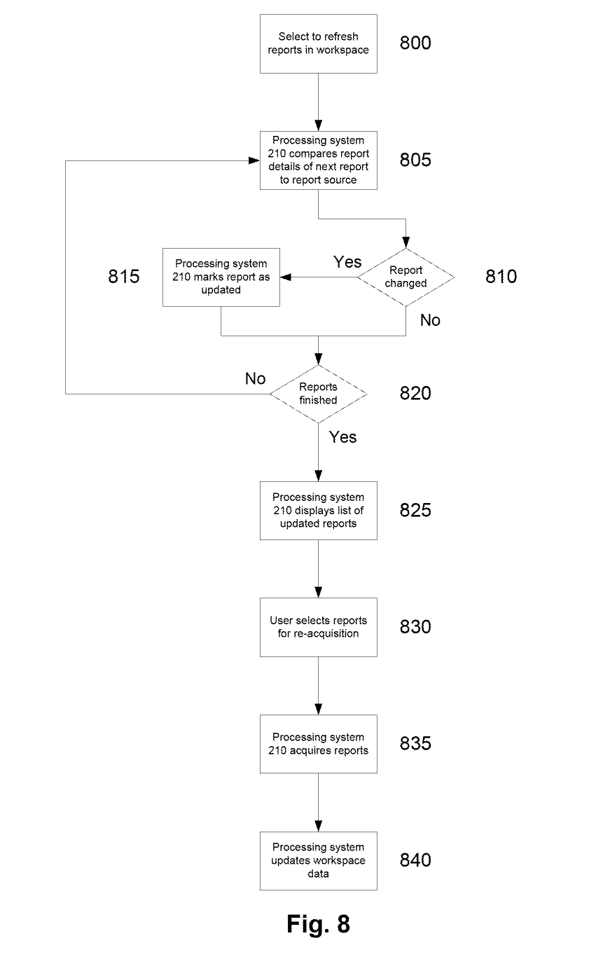

An example of process for updating reports in the workspace will now be described with reference to FIG. 8.

In this example, at step 800 a user selects to refresh reports in a workspace. This may be performed for any one of a number of reasons, such as to periodically update reports to ensure these are up to date, or the like. As part of this process, the system might automatically check a frequency or timing of updates of a report source, so that checks are only performed in the event that it is possible that data has been updated since the last check was performed.

At step 805 the processing system 210 compares report details for the next report to a report source. Thus, this could include comparing details regarding the most recent change to the report stored in the workspace and comparing this to the most recent change in the report as specified by the report source. The processing system 210 uses this to determine if the report has changed at step 810 and if so the processing system marks the report as updated at 815. The processing system 210 then determines if all reports are finished at step 820 and if not returns to step 805 allowing extra reports to be considered.

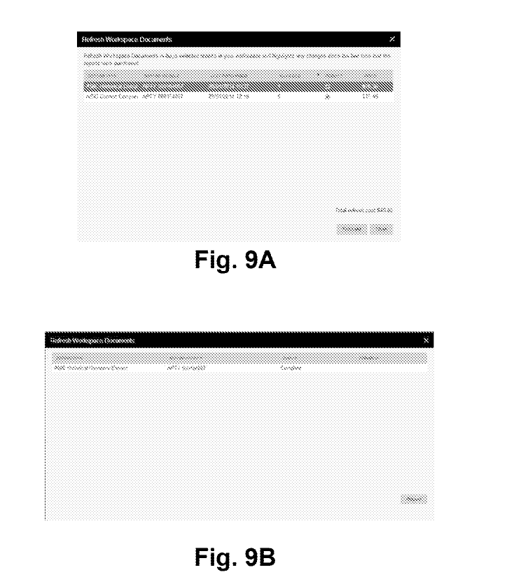

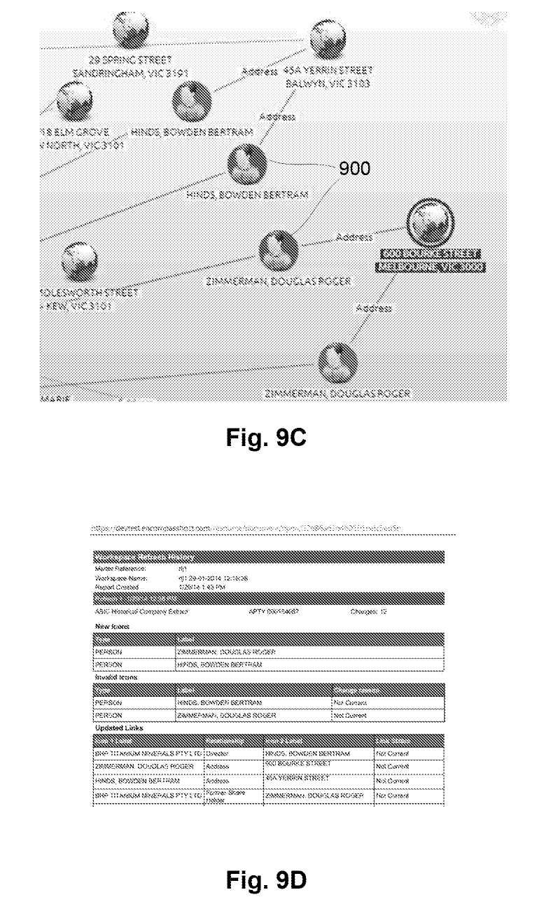

Once all reports have been reviewed the processing system 210 displays a list of updated reports at step 825, allowing a user to select reports for reacquisition. An example of this is shown in FIG. 9A. In this regard, FIG. 9A shows two types of reports and associated information such as when these reports were last purchased and how old the reports are. This, together with additional information such as the cost of the reports, can be used to allow the user to select whether to repurchase the reports.

At step 830 the user selects reports for reacquisition allowing the processing system 210 to purchase the reports at step 835, with this being confirmed via the user interface, as shown in FIG. 9B. At step 840 the processing system operates to update the workspace corporate data to include the new report. Thus, information from the report can be imported into the workspace corporate data and added to the network representation, as shown in FIG. 9C. In this instance, one of the entities added to the network representation is similar to an existing entity, and this is therefore flagged as a potential matching entity as shown at 900, allowing the user to go through a process of matching and potentially merging the entities, as will be described in more detail below. Additionally, the change log forming part of the workspace data will also be updated as shown in FIG. 9D.

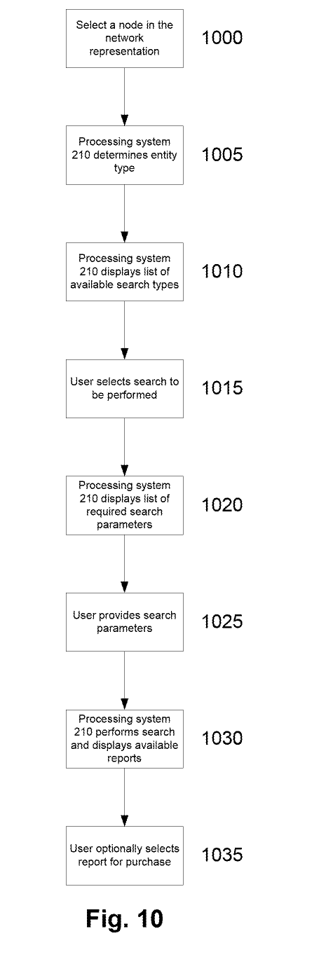

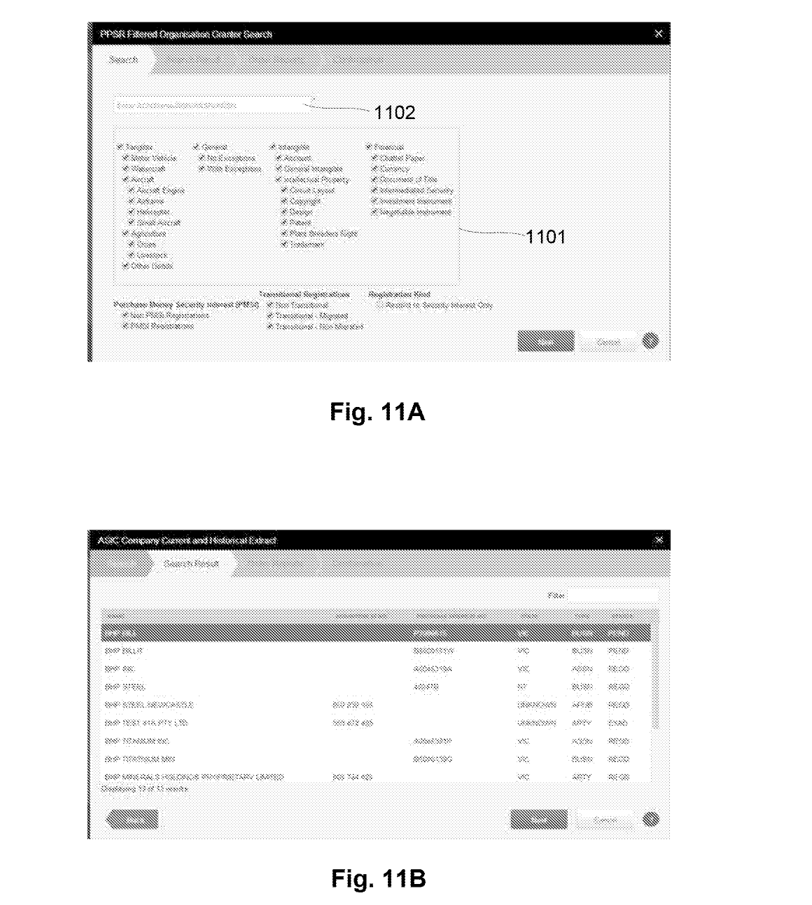

An example mechanism for performing a search will now be described with reference to FIGS. 10, 11A and 11B.

In this example, at step 1000 the user selects a node in the network representation. The processing system 210 determines an entity type associated with the node, such as an individual, company or the like, at step 1005 and uses this to access search rules stored in the database 211, or the like. The search rules define the different types of searches that can be performed for each entity type, and can include information such as the different report sources that can be searched and the search parameters needed for each different type of search.

At step 1010, the processing system 210 uses the search rules to display a list of available search types for the selected entity type, allowing the user to select a search to be performed at step 1015. The processing system then displays a list of required search parameters at step 1020 and an example of this is shown in FIG. 11A. In particular, this can include different parameters in the form of options that can be selected 1101, as well as a field 1102 allowing the user to enter relevant values, such as names or other identifiers of relevant entities or the like.

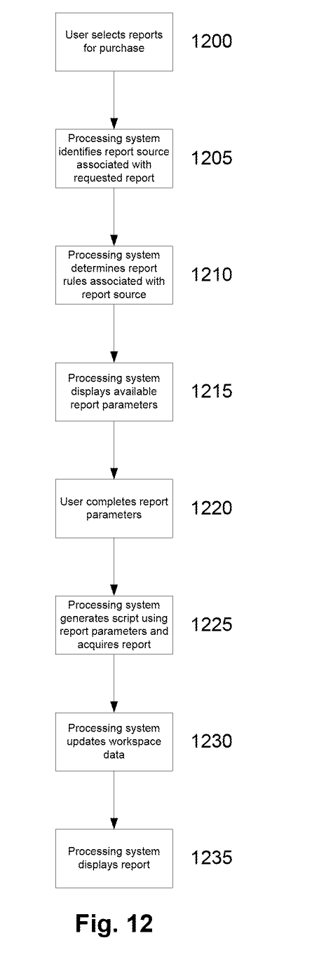

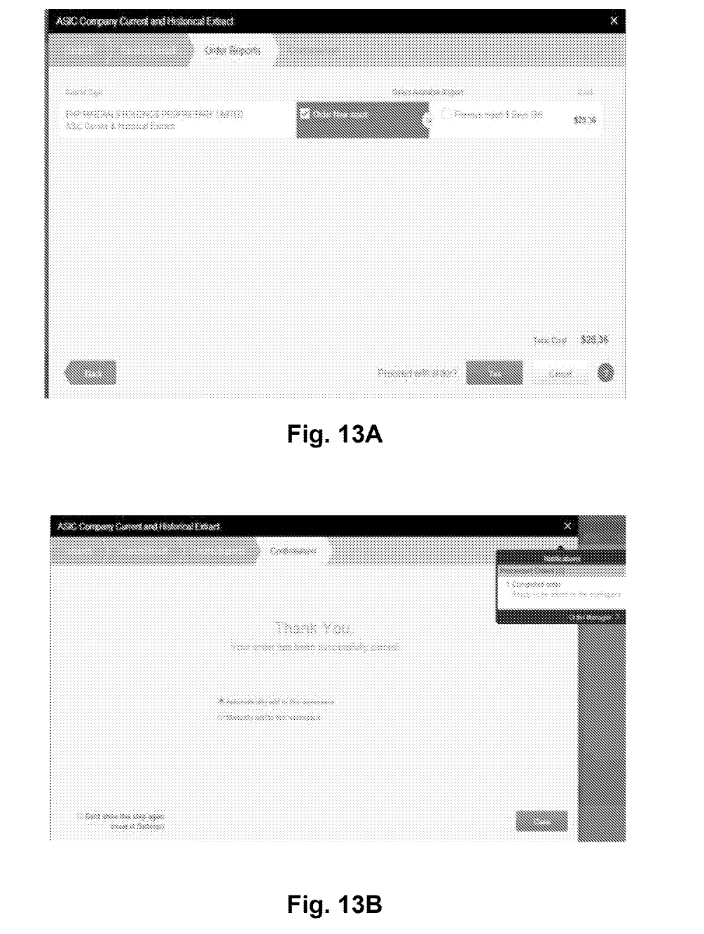

At step 1025 the user completes the relevant search parameters, allowing the processing system 210 to perform a search and display available reports at step 1030, as shown for example in FIG. 11B. This allows the user to optionally select a report for purchase as will now be described with reference to FIGS. 12 and 13A and 13B.

In particular, at step 1200, the user selects a report for purchase, as shown in FIG. 13A. This might be performed following a search, as described above, or alternatively if the user has asked that existing reports are updated.

At step 1210, the processing system 210 identifies a report source associated with the requested report using this to determine report rules associated with the report. The report rules are typically stored in the database 211 and are used to allow the processing system to generate report requests, defining any required report parameters, as well as the necessary interactions required to obtain the report from the report source. The report rules are therefore typically established through prior interaction with the report source, as will be appreciated by persons skilled in the art.

At step 1215 the processing system displays available report parameters to the user, allowing the user to complete these at step 1220. It will be appreciated that this may not be required if the report is being ordered as the result of a search as the report parameters may be the same as the search parameters, or derived from the search results, in which case the report parameters can be derived automatically by the processing system 210.

At step 1225 the processing system generates a script using the report parameters and the report rules. The script allows the processing system to perform the sequence of steps required to the order the report from the report source, thereby allowing this to be ordered at the user's discretion. Following ordering of the report, a confirmation of successful ordering can be displayed as shown in FIG. 13B, before the processing system 210 updates the workspace data, in particular adding details of the ordered report to the change log and then displaying the report and/or network representation to the user at step 1240.

As part of this process, multiple reports could be acquired during the same process, with the reports being combined into a single set of results for easier viewing. In this regard, the reports can be combined in accordance with defined workspace rules, so that a dynamically tailored report can be generated automatically.

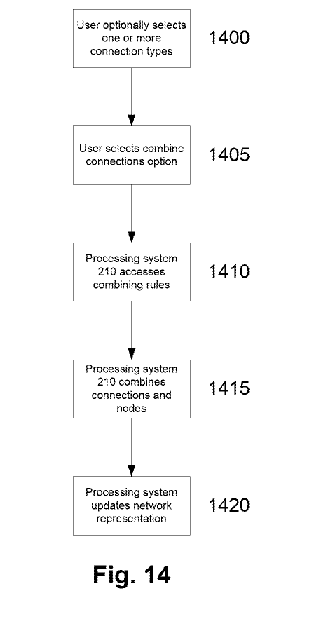

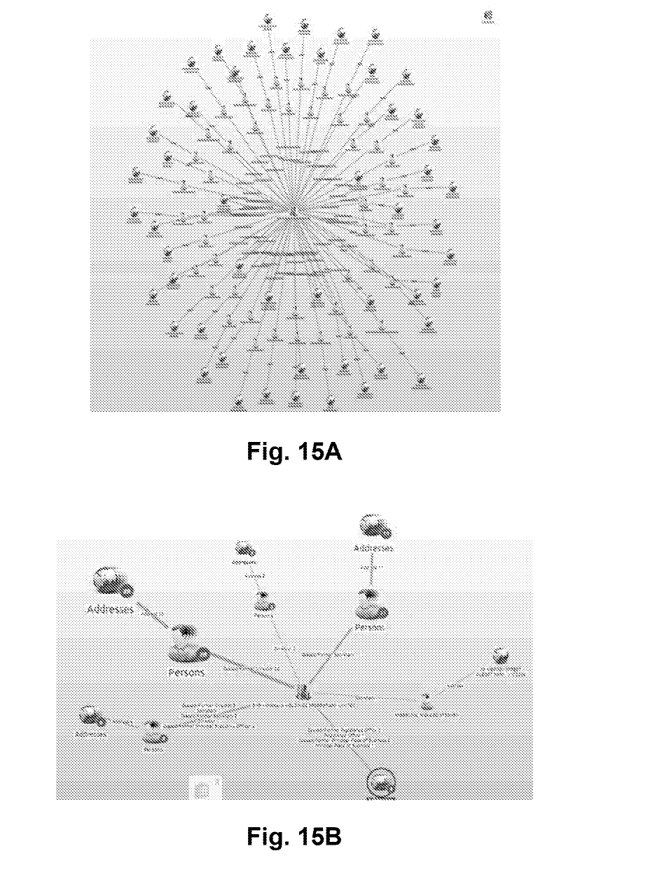

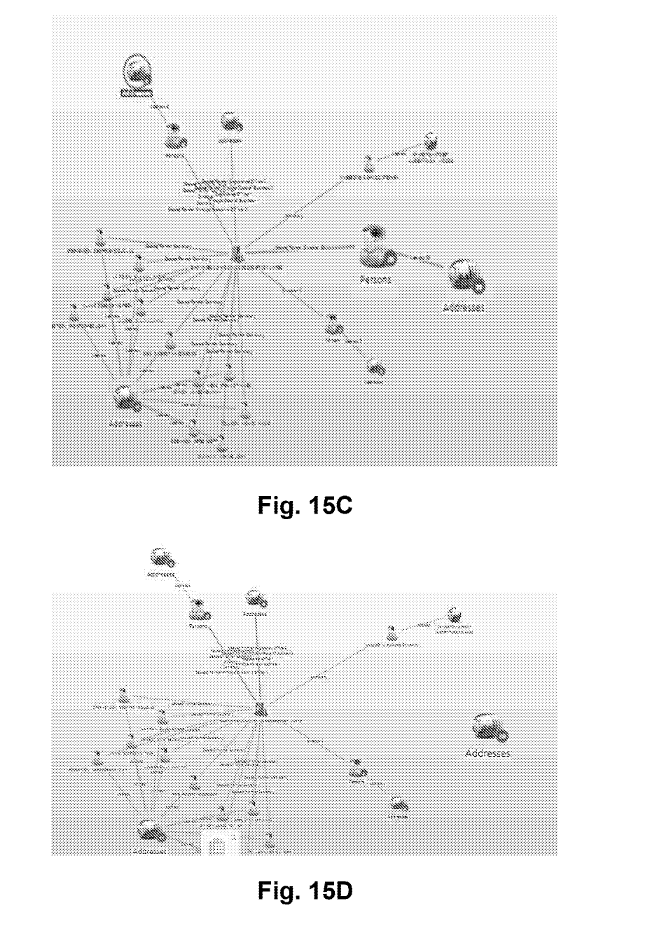

An example of a method for combining connections and nodes within network representations will now be described with reference to FIGS. 14 and 15A to 15D.

In this regard, an example of a network representation in which connections have not been combined is shown in FIG. 15A. It is apparent from this example that the network representations can become cluttered with a large number of nodes and corresponding connections, particularly when the network representation relate to a large number of entities. The cluttering of the network representation makes it difficult for user to navigate through the representation and understand the relationships between different entities.

Accordingly, the process of combining connections is performed in order to produce a more uncluttered version of the network representation. It should be noted that by combining connections, and subsequently corresponding nodes, the nodes and connections may still remain present in the network representation and hence can still be explored, but they are combined so as to reduce the overall number of connections and nodes displayed.

In any event, in this instance at step 1400 the user optionally selects one or more connection types. This is not necessarily required as the user can alternatively simply operate to combine all connections of common connection types, in which case selection of specific connection types is not required.

At step 1405, the user selects a combine connections option, causing the processing system 210 to access combining rules at step 1410, specifying for each connection type, how the connections should be combined. At step 1415, the processing system 210 combines the connections and the corresponding nodes and then updates the network representation at step 1420. An example of this is shown in FIG. 15B in which all connections of a common connection type are initially combined so as to produce a limited number of connections with each connection corresponding to a number of connections of the same connection type.

As well as combining connections, a similar process can be used to expand selected connections and an example of this is shown in FIG. 15C. For example, a user could select one of the combined connections, causing this to be expanded. In this example, a connection corresponding to a “secretary” relationship is expanded, so all the company secretaries of an organisation are shown. In the example of FIG. 15D, the connections corresponding to “former directors” are then hidden, using a hiding process that will be described in more detail below.

It will be appreciated from the above that a complex network representation similar to that shown in FIG. 15A can be simplified and then progressively expanded, allowing users to more easily navigate and find information of interest.

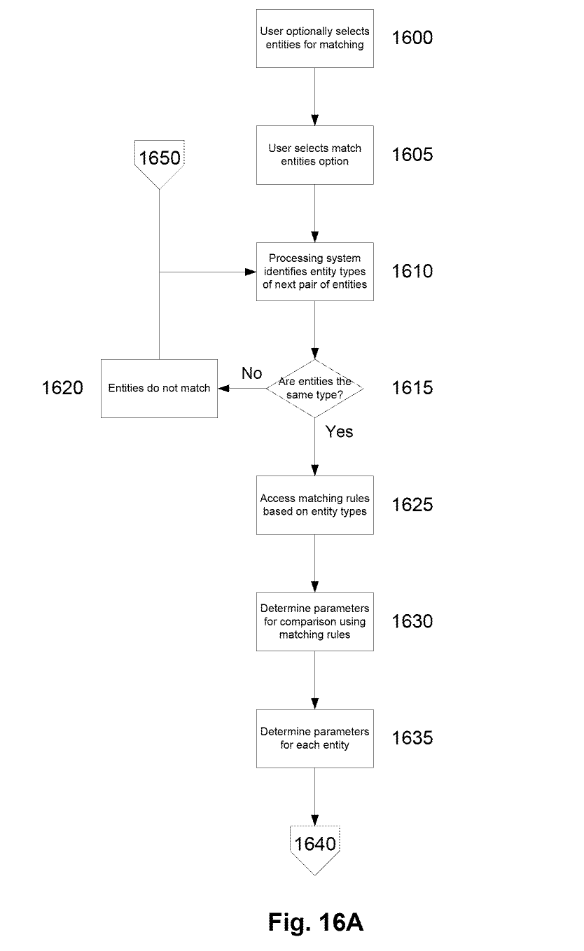

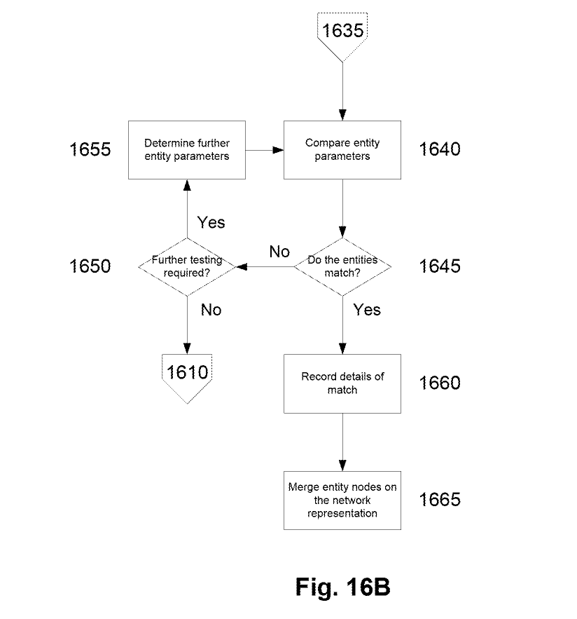

Network representations may often contain duplicated entities, for example if a single entity is identified in multiple different reports. In this instance, as long as the entities are the same entity, the nodes on the network representations can be merged. However, it is not always clear whether the entities are indeed the same. For example, entities could have a similar name but different addresses but may still nevertheless be the same entity. In order to resolve this entity matching process can be performed and an example of this will now be described with reference to FIG. 16A and FIG. 16B.

The entity matching process can be performed either manually, automatically or using a combination of manual and automated processes, as will now be described. In the manual process at step 1600, the user optionally selects specific entities for matching. The user then selects a match entities option in the workspace, at step 1605 causing the following matching process to be performed. In the event that no entities are selected by the user, an automated process can be performed in which all of the entities are compared in a pairwise fashion.

At 1610, the processing system 210 identifies entity types of a next pair of entities. Thus, it will be appreciated if the user has selected entities for matching at step 1600, this is the pair of entities the user has selected. Otherwise it is a next pair of entities in the network representation.

At step 1615 the processing system 210 determines if the entities are of the same entity type. In this regard, it will be appreciated that if one entity is an organisation and another is an individual, these cannot represent a match and accordingly, this represents a first high level review of the entities to determine if they match.

Accordingly, if it determined that the entity types do not match, then it is determined that the entities do not match at step 1620. At this point, in the manual approach, the process will simply end. However, in the automated approach, the processing system 210 returns to step 1610, allowing a next pair of entities to be considered.

Assuming the entity types are the same, at step 1625, the processing system 210 accesses matching rules based on the entity types of the pair of entities. The matching rules define what is required in order to a match to be confirmed and it will be appreciated that this assessment will typically vary depending on the nature of the entities being assessed.

In particular the rules will specify the type of entity parameters that should be compared. Thus, for example, if the entity type is an individual the matching rules could involve comparing a name, address and date of birth, whereas if the entity types are corporations the matching rules could involve comparing parameters such as the main, ABN, ACN or the like.

Additionally, the rules will also typically define the degree of similarity that is required in order for a match to be found. For example, in comparing individuals, if the names and dates of birth match but addresses don't, this doesn't necessarily preclude a match and further assessment may be required as the address of an individual can change over time. In contrast, if the names or dates of birth do not match, as these parameters typically do not change, then a match would typically be excluded.

Accordingly, at step 1630 the processing system 210 uses the matching rules to determine parameters for comparison. At step 1635, the processing system 210 determines value of the parameters for each entity and then compares these at step 1640. The comparison can determine if the parameters are identical, but typically takes into account non-identical matches, as might arise for example due to the use of different formats, misspellings, or the like. This can be achieved using a variety of techniques, such as pattern matching, distance matching, fuzzy logic processes, or the like.

At step 1645 if it is determined that the entities do not necessarily match, it is then assessed whether further testing is required at step 1650. If so, further entity parameters are determined and then compared at step 1655, with this being repeated until a definitive match or no match is ascertained. As part of this process, manual intervention may be used to resolve potential matches. For example, the potential matches could be displayed to a user, allowing the user to make a manual assessment of whether a match should be found.

In the event that a match is determined, at step 1660 the processing system 210 records details of the match before merging entity nodes on the network representation at 1665. Otherwise, the process can return to step 1610, allowing the next pair of entities to be compared.

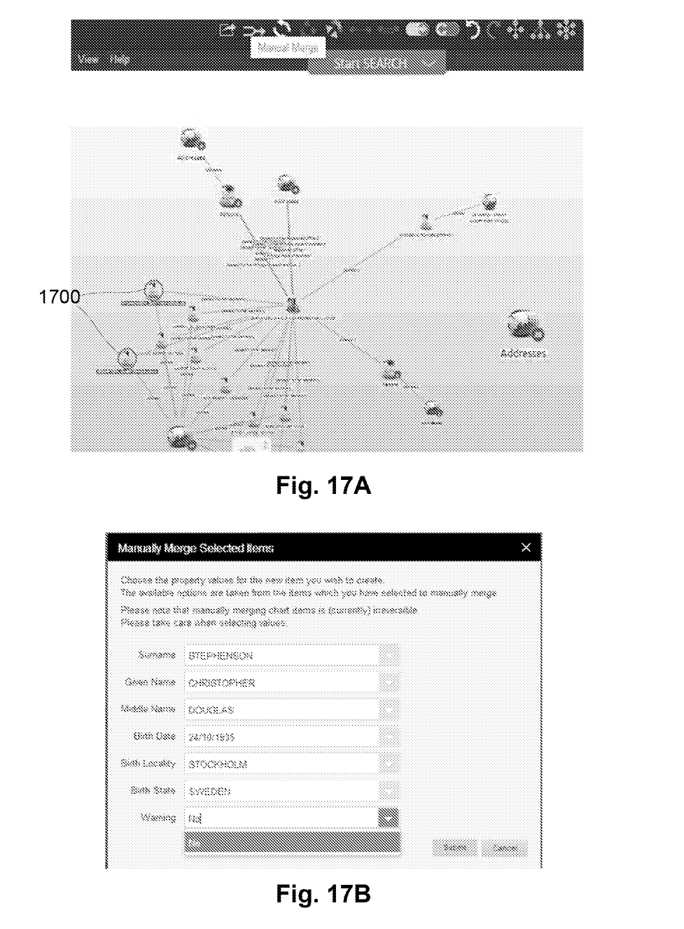

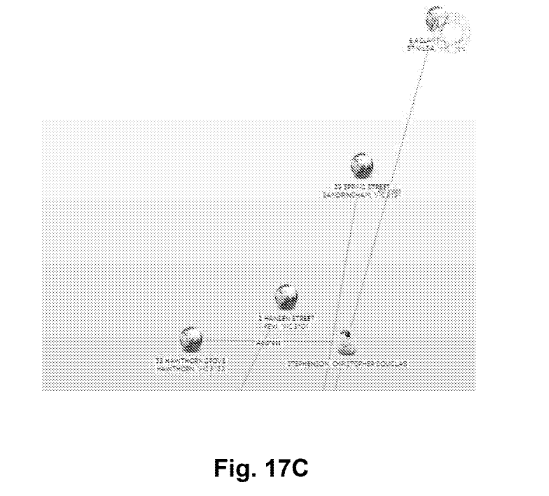

An example of the above described process is shown in FIGS. 17A to 17C. In this example, the user selects the name, date of birth and locality of entities to be matched and in this case the entities meeting these requirements are highlighted in blue circles at 1700. Assuming the entities match then a modified version of the network representation would be as shown in FIG. 17C.

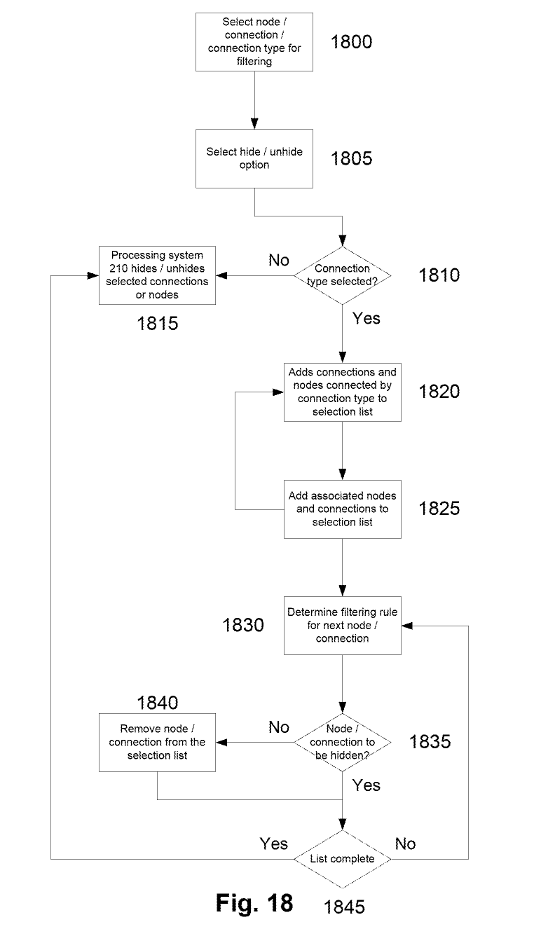

An example of process for node/connection filtering will now be described with reference to FIG. 18.

In particular, in this example filtering can be performed on the basis of specific nodes or connections or on the basis of a connection type. Accordingly, at step 1800 the user selects a node, connection or connection type for filtering. At step 1805 the user selects a hide/unhide option displayed by the processing system 210. Accordingly, it will be appreciated that this allows specific nodes, connections or connection types to be hidden and then subsequently unhidden as required.

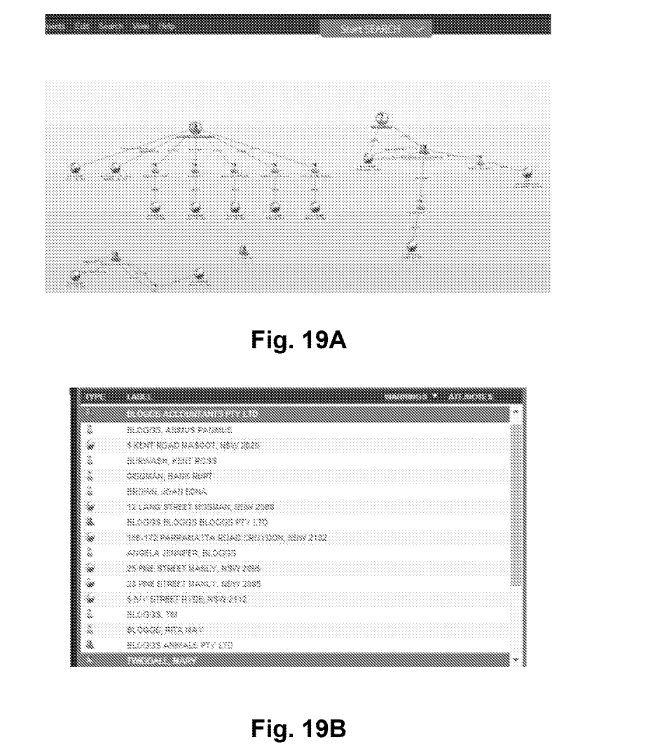

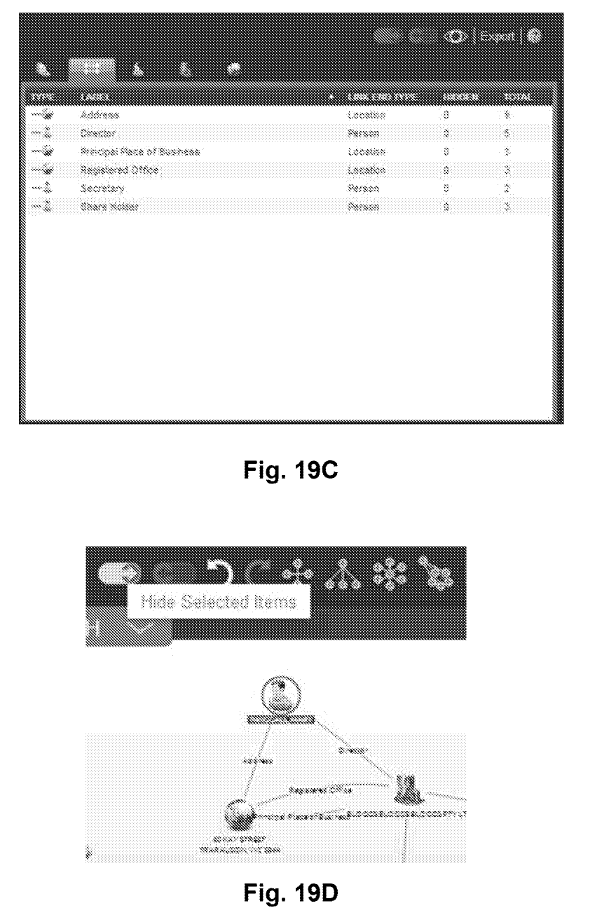

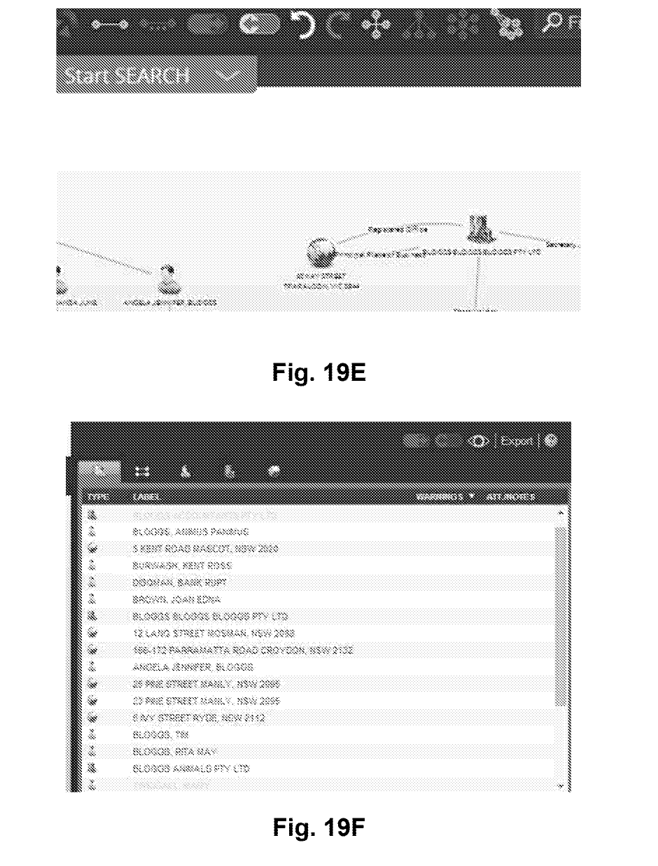

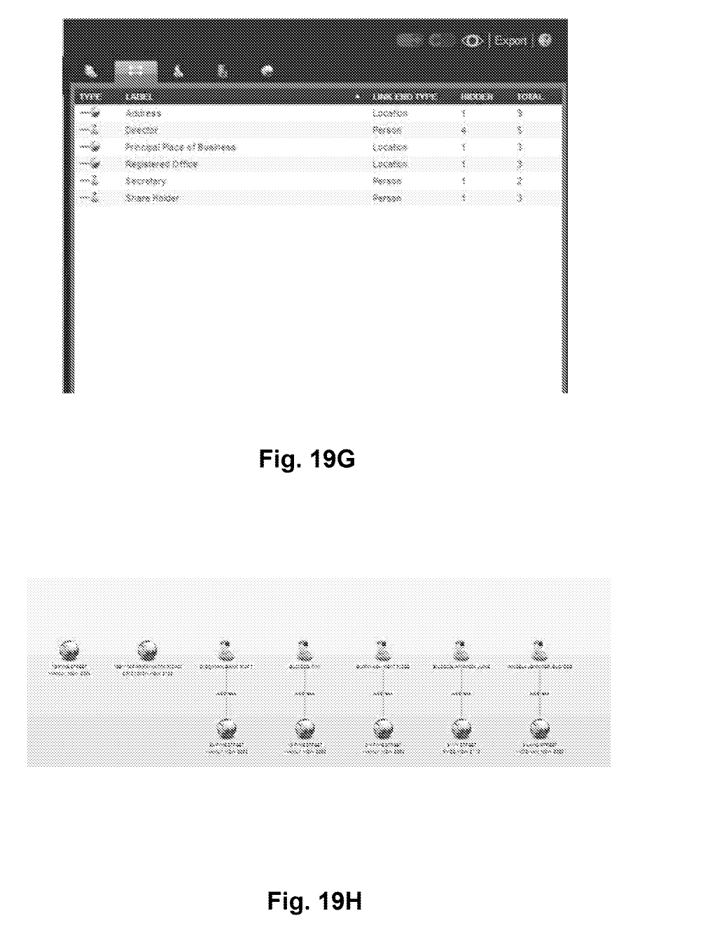

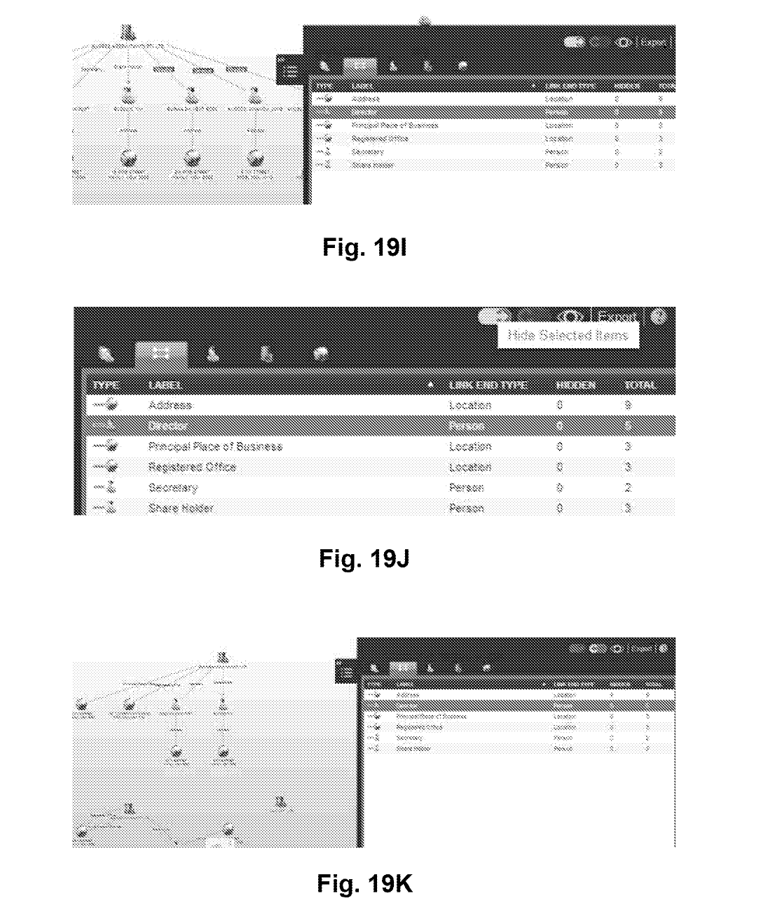

In this example, it is determined at step 1810 that the connection type has been selected and if not the processing system 210 simply hides or unhides the selected connections or nodes. Examples of this are shown in FIGS. 19A to 19H.

In particular, in this example the user is initially presented with network representation shown in FIG. 19A and selects two individual nodes for hiding, as also shown in the node list in FIG. 19B. The user can also view details of the different connections, with the number of connections of each type and the number of hidden connections being shown in FIG. 19C. Following this, the user can select to hide the selected entities using the hide option shown in FIG. 19D. In this instance by selecting the hide items option, the selected nodes are hidden in the network representation, as shown in FIG. 19E. Additionally, the hidden nodes can be indicated as hidden in a node list shown in FIG. 19F, with corresponding hidden connections shown in the connections list in FIG. 19G. Once this has been performed, further nodes can be selected for filtering as shown for example in FIG. 19H and the nodes.

Alternatively, a connection type can be selected from the connection list, as shown for example in FIG. 19I, in which a “director” connection is selected, with a hide option being selected as shown in FIG. 19J. In this case, at step 1820 the processing system 210 adds connections and nodes connected by the connection type to a selection list. At step 1825 the processing system 210 identifies associated nodes and connections, and also adds these to the selection list. In this regard, the associated connections would be those connected to the nodes connected by the connection type. This process can be repeated a number of times so that successive related nodes and connections are identified.

At step 1830 the processing system 210 determines a filtering rule for a next node or connection. In this regard, a different filtering rule is used for each type of connection to allow the assessment of whether the connection should be hidden to be tailored depending on the connection type. For example, if a parent connection is hidden, associated child connections should also be hidden, whilst the reverse is not necessarily true.

At step 1835 the processing system 210 assesses whether a next node or connection in the selection list should be hidden in accordance with the rule. At step 1840 if it is determined that the node should not be hidden it is removed from the selection list. Otherwise at step 1845 the processing system 210 determines if the list is complete and if not returns to step 1830 to process the remaining nodes and connections in the selection list.

In the event that the list is complete, the processing system 210 moves onto step 1815 removing selected connections or nodes on the connection list, as shown in FIG. 19K.

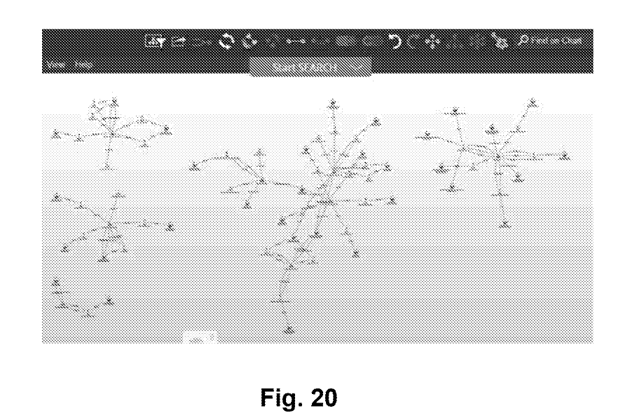

An example of a second network representation is shown in FIG. 20.

In this example, the second network representation is in the form of a summary chart, in which each group in the chart corresponds to a report in the workspace. It will be appreciated that this can be used to provide a high level overview and that the second network representation can otherwise be manipulated in a similar manner to the network representation described above. This will not therefore be described in any further detail.

Accordingly, the above described techniques provide mechanisms for managing and interacting with corporate data.

The ability to manage corporate data can assist in addressing the needs of a user who requires commercial information about an entity allowing them to search one or more information sources, select and purchase reports that are relevant to their needs. Reports can be obtained, usually on a commercial basis, from disparate information sources in a chained fashion, where one report contains information that enables a search to be made for the next report that is of interest. These can then be converted into a network representation and retained in a workspace, allowing user to manipulate the corporate data to gain a greater understanding of its meaning, whilst also allowing this to be accessed over an extended period of time.

The information held in the workspace is dynamic because it is extracted from information sources that are themselves changing in time, in a way that is outside the control of the user. Accordingly, the techniques provide mechanisms that allow for updating and tracking of changes in corporate data so that the content of the workspace can represent not only the current state of the originating sources but also how its content has varied in time. To achieve this, the reports can be refreshed to keep them synchronized with the underlying information source, with changes being propagated to the network representation. This can be performed using the techniques described above with respect to FIG. 8, as will be appreciated by person skilled in the art. This allows users to verify at minimum cost if the information forming the chart is current, and also demonstrate visually the change history, and view prior versions of reports.

Additionally, as the reports can be complex, the processes allow users to manipulate the charts to view simplified or summarized views of the network chart created automatically, thereby assisting them in increasing their understanding of the information, especially if the user is not the author who created the original chart. This includes both automated and manual processes for summarizing and simplifying a network chart that has been generated automatically from one or more reports to thereby assist the user to better visualize and share the results. For example, this can include hiding or combining particular types of nodes and links that are not of interest to the task at hand, because they obscure the essential pieces of information.

Furthermore, the reports often have a structure in which entities from a single report are tightly connected whereas the connections across reports are typically sparser. They are also frequently built in a particular way by adding the entities extracted from each report serially. The above techniques therefore also allow for the generation of automatic chart summaries, which can simply the task for users to review and understand the reports and how they interrelate.

The technology also supports the sharing and organization of workspaces, allowing multiple users to interact with the corporate data in accordance with the standard workflows of an organisation.

Accordingly, the above described processes allow users, often with minimal training, to search for commercial reports, which are often quite complex and which can return voluminous amounts of data, make purchase decisions about which reports to purchase, and generate of resulting derived reports both as workspaces and as textual reports usually for other users to examine.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A method of managing corporate data, the method including, in one or more electronic processing devices:
a) hosting a workspace associated with workspace corporate data;
b) providing users access to the workspace in accordance with user access permissions to thereby allow the users to perform actions relating to the workspace corporate data, the actions including at least one of:
i) selecting workspace corporate data to be acquired from one or more corporate data sources;
ii) viewing the workspace corporate data;
iii) manipulating the workspace corporate data; and,
iv) updating the workspace corporate data.

2. A method according to claim 1, wherein the method includes, in the one or more electronic processing devices, displaying a workspace representation, the workspace representation including at least one of:
a) an indication of the workspace corporate data;
b) an indication of one or more reports forming part of the workspace corporate data;
c) an indication of one or more entities to which the workspace corporate data relates; and,
d) a network representation of the corporate data.

3. A method according to claim 1, wherein the method includes, in the one or more electronic processing devices:
a) generating a link indicative of a workspace address; and,
b) providing the link to users to thereby allow user access to the workspace by:
i) generating a notification including the link; and,
ii) transferring the notification to the user.

4. (canceled)

5. A method according to claim 1, wherein the method includes, in the one or more electronic processing devices:
a) determining, in accordance with input commands from a first user, a user identifier indicative of an identity of a second user permitted to access the workspace;
b) recording an indication of the second user identifier as part of user data associated with the workspace;
c) determining, in accordance with input commands from the first user, user permissions associated with the second user, the user permissions being indicative of actions the second user can perform; and,
d) recording an indication of the user permissions as part of the user data.

6. (canceled)

7. A method according to claim 5, wherein the method includes, in the one or more electronic processing devices:
a) receiving a share workspace request from the first user;
b) displaying a list of potential users; and,
c) determining the user identifier of the second user in accordance with selection of a potential user from the list of users.

8. (canceled)

9. A method according to claim 5, wherein the method includes, in the one or more electronic processing devices:
a) receiving a workspace access request including an indication of a user identifier;
b) comparing the user identifier to the user data; and,
c) selectively providing access to the corporate data in the workspace in accordance with the results of the comparison.

10. (canceled)

11. A method according to claim 1, wherein the method includes, in the one or more electronic processing devices:
a) determining a selection of workspace corporate data to be acquired in accordance with user input commands from a first user;
b) displaying the indication of the selection to a second user;
c) acquiring the corporate data in accordance with input commands from the second user; and,
d) displaying the workspace corporate data to the first user.

12. (canceled)

13. A method according to claim 1, wherein the method includes, in the one or more electronic processing devices:
a) determining, in accordance with input commands from a user, changes in at least one of:
i) the workspace corporate data; and,
ii) a representation of the workspace corporate data; and,
b) recording an indication of the changes together with a user identifier of the user.

14. A method according to claim 1, wherein the workspace corporate data includes one or more reports relating to one more entities, and wherein the method includes, in the one or more electronic processing devices:
a) identifying, from a report source, changes in the reports; and,
b) selectively updating a report by acquiring an updated report from the report source in accordance with input commands from a user.

15. A method according to claim 14, wherein the method includes, in the one or more electronic processing devices, at least one of:
a) comparing report details of each report to report details from a report source to determine changes in the reports; and,
b) displaying an indication of the changes in reports to allow a user to select reports for updating.

16. (canceled)

17. A method according to claim 14, wherein the method includes, in the one or more electronic processing devices:
a) comparing acquired updated report to the workspace corporate data to identify duplicate reports; and,
b) recording an indication of acquired updated reports.

18. (canceled)

19. A method according to claim 1, wherein the workspace corporate data includes one or more reports relating to one more entities and wherein the method includes, in the one or more electronic processing devices:
a) determining at least one selected entity in accordance with input commands from a user;
b) performing a search associated with the at least one selected entity to identify at least one report associated with the entity; and,
c) selectively acquiring the report in accordance with user input commands.

20. A method according to claim 19, wherein the method includes, in the one or more electronic processing devices:
a) determining an entity type associated with the at least one selected entity;
b) performing the search at least partially in accordance with the entity type;
c) determining search rules; and,
d) performing the search at least partially in accordance with the search rules.

21. (canceled)

22. (canceled)

23. (canceled)

24. (canceled)

25. A method according to claim 1, wherein the method includes, in the one or more electronic processing devices:
a) determining a report to be acquired in accordance with user input commands;
b) identifying a report source associated with the report to be acquired;
c) generating a report request in accordance with the report source; and,
d) transferring the report request to the report source, the report source being responsive to the report request to provide the report.

26. (canceled)

27. (canceled)

28. A method according to claim 25, wherein the method includes, in the one or more electronic processing devices:
a) determining report rules in accordance with the report source; and,
b) generating the report request in accordance with the report rules.

29. A method according to claim 1, wherein the method includes, in the one or more electronic processing devices, generating a network representation, wherein the network representation includes:
a) a number of nodes, each node being indicative of a corresponding entity; and,
b) a number of connections between nodes, the connections being indicative of relationships between the entities.

30. A method according to claim 29, wherein the method includes, in the one or more electronic processing devices, modifying the representation by at least one of:
a) replacing multiple connections and associated nodes with a single connection and node by:
i) identifying a respective plurality of connections having a common connection type for each of a number of connection types;
ii) replacing each plurality of connections with a single connection; and,
iii) replacing nodes at each end of each of the plurality of connections with a respective single node;
b) replacing multiple connections of a common connection type with a single connection by:
i) determining a selected connection type in accordance with input commands from a user;
ii) identifying a plurality of connections having the selected connection type;
iii) replacing the plurality of connections with a single connection; and,
iv) replacing nodes at each end of each of the plurality of connections with a respective single node;
c) by replacing multiple nodes of matching entities with a single node by:
i) determining matching entities; and,
ii) modifying the network representation by merging nodes associated with the matching entities; and,
d) selectively hiding at least one of the nodes and the connections by:
i) determining a selected connection type in accordance with input commands from a user;
ii) identifying a plurality of connections having the selected connection type;
iii) replacing the plurality of connections with a single connection; and,
iv) replacing nodes at each end of each of the plurality of connections with a respective single node.

31. (canceled)

32. (canceled)

33. (canceled)

34. A method according to claim 30, wherein the method includes, in the one or more electronic processing devices, determining the matching entities based on at least one of:
a) input commands from a user;
b) an entity type; and,
c) entity parameters.

35. (canceled)

36. (canceled)

37. (canceled)

38. A method according to claim 29, wherein the method includes, in the one or more electronic processing devices, generating a second network representation including a report as a respective node in the representation.

39. (canceled)

40. A method of managing corporate data, the corporate data includes one or more reports relating to one more entities, the method including, in one or more electronic processing devices:
a) comparing at least some report details of each report to at least some report details from a report source;
b) identifying changes in reports in response to results of the comparison;
c) displaying an indication of the changes;
d) determining at least one selected report for updating in accordance with input commands from a user; and,
e) updating the at least one report by acquiring an updated report from the report source.

41. (canceled)

42. (canceled)

43. (canceled)

44. Apparatus for managing corporate data, the apparatus including in one or more electronic processing devices that:
a) host a workspace associated with workspace corporate data;
b) provide users access to the workspace in accordance with user access permissions to thereby allow the users to perform actions relating to the workspace corporate data, the actions including at least one of:
i) selecting workspace corporate data to be acquired from one or more corporate data sources;
ii) viewing the workspace corporate data;
iii) manipulating the workspace corporate data; and,
iv) updating the workspace corporate data.

45. Apparatus for managing corporate data, the corporate data includes one or more reports relating to one more entities, the apparatus including one or more electronic processing devices that:
a) compare at least some report details of each report to at least some report details from a report source;
b) identify changes in reports in response to results of the comparison;
c) display an indication of the changes;
d) determine at least one selected report for updating in accordance with input commands from a user; and,
e) update the at least one report by acquiring an updated report from the report source.

46. (canceled)

47. (canceled)

48. (canceled)
